(19) United States
(12) Patent Application Publication
(10) Pub. No.: US 2023/0065252 A1
(43) Pub. Date: Mar. 2, 2023

(54) TOY SYSTEM AND A METHOD OF OPERATING THE TOY SYSTEM

(71) Applicant: Lego A/S, Billund (DK)

(72) Inventors: Philip Kongsgaard DØSSING, Aarhus C (DK); Andrei Zavada, Horsens (DK); Jesper Soederberg, Galten (DK); Bjørn Carlsen, Kolding (DK)

(21) Appl. No.: 17/953,659

(22) Filed: Sep. 27, 2022

Related U.S. Application Data
(63) Continuation-in-part of application No. 17/945,354, filed on Sep. 15, 2022.
Application No. 17/945,354 is a division of application No. 15/751,073, filed on Feb. 7, 2018, now Pat. No. 11,504,623.
Application No. 15/751,073 is a continuation-in-part of application No. 17/257,105, filed on Dec. 30, 2020.

(30) Foreign Application Priority Data
Aug. 17, 2015 (DK) PA 201570531
Jul. 6, 2018 (DK) PA 201870466

(51) Int. Cl. A63F 13/655; A63F 13/98; A63F 13/65; A63F 13/213

(52) U.S. Cl. CPC A63F 13/655; A63F 13/98; A63F 13/65; A63F 13/213

(57) ABSTRACT

A toy system including a plurality of toy construction elements, an image capturing device, and a processor, wherein the image capturing device is operable to capture one or more images of a toy construction model constructed from the toy construction elements. The processor is configured to execute a digital game configured to cause the processor to provide a digital play experience. The processor is configured to receive an unlock code and unlock virtual objects for use in the digital play experience. The virtual objects are associated with toy construction elements. The processor is configured to receive images captured by the image capturing device, recognize one or more toy construction elements within the images, and provide a digital play experience involving the unlocked virtual. Objects.

### CROSS-REFERENCE TO RELATED APPLICATIONS

The present application is a Continuation-in-Part of U.S. patent application Ser. No. 17/945,354, filed Sep.15. 2022, which is a Divisional of and claims the benefit of U.S. patent application Ser. No. 15/751,073, filed Feb. 7, 2018 and published on Sep. 20, 2018 as U.S. Patent Publication No. 2018′0264365 A1, which is a U.S. National Stage Application of International Application No. PCT/EP2016′069403, filed on Aug. 16, 2016 and published on Feb. 23, 2017 as WO 2017/029279 A2, which claims the benefit and priority of Danish Patent Application No. PA 201570531, filed on Aug. 17, 2015, each of which is incorporated herein by reference in its entirety for any purpose whatsoever.

The present application is also a Continuation-in-Part of U.S. patent application Ser. No. 17/257,105, filed Dec. 30, 2020 and published on Apr. 29, 2021 as U.S. Patent Publication No. 2021/0121782 A1, which is a U.S. National Stage Application of International Application No. PCT/EP2019i066886, filed on Jun. 25, 2019 and published on Jul. 30, 2020 as WO 2020/007668, which claims the benefit and priority to Danish Patent Application No. PA 201870466, filed on Jul. 6, 2018, each of which is incorporated herein by reference in its entirety for any purpose whatsoever.

### FIELD OF THE DISCLOSURE

The present disclosure relates in one aspect to methods of creating a virtual game environment. According to a further aspect, the disclosure relates to an interactive game system implementing one or more of the methods of creating a virtual game environment. According to a yet further aspect the disclosure relates to a method of playing an interactive game using one or more of the methods of creating a virtual game environment. According to yet another aspect, the present disclosure relates to image processing and, in particular, to voxelization. Still further, the present disclosure relates to computer vision technology for toys-to-life applications and, more particularly, to a toy system employing such technology.

### BACKGROUND

Different attempts of integrating virtual representations of physical objects into a virtual game play have been made. However, a close link between the physical world and a virtual game play stimulating the interactive involvement of the user and, in particular, stimulating the development of different skills by children's game playing is still missing. Therefore, according to at least one aspect disclosed herein, there is a need for a new approach to interactive game play.

In many image processing methods, e,g, when creating a virtual representation of physical objects into a virtual game play, it is often desirable to create a three-dimensional digital three-dimensional representation of an object in a three-dimensional voxel space, a process referred to as voxelization.

Conventional techniques for rendering three-dimensional models into two-dimensional images are directed towards projecting three-dimensional surfaces onto a two-dimensional image plane. The image plane is divided into a two-dimensional array of pixels (picture elements) that represent values corresponding to a particular point in the image plane. Each pixel may represent the color of a surface at a point intersected by a ray originating at a viewing position that passes through the point in the image plane associated with the pixel. The techniques for rendering three-dimensional models into two-dimensional images include rasterization and raytracing.

Voxelization can be regarded as a three-dimensional counterpart to the two-dimensional techniques discussed above, Instead of projecting three-dimensional surfaces onto a two-dimensional image plane, three-dimensional surfaces are rendered onto a regular grid of discretized volume elements in a three-dimensional space. A voxel (volumetric picture element) is a volume element, such as a cube, that represents a value of a three-dimensional surface or solid geometric element at a point in the three-dimensional space.

There are multiple techniques for rendering three-dimensional model data into a three-dimensional image comprising a plurality of voxels, see e.g. U.S. Pat. Nos. 9,245,363, 8,217,939 or 6,867,774.

Nevertheless, at least according to one aspect disclosed herein, it remains desirable to provide alternative methods and, in particular, methods that are computationally efficient.

Further, different attempts of integrating physical objects into virtual game play have been made. However, it remains desirable to provide ways of linking the physical world and a virtual game play which may stimulate the interactive involvement of the user and provide entertaining game play. Therefore there is a need for a new approach to interactive game play.

Most toy-enhanced computer games or so-called toys-to-life systems currently involve systems wherein toys must have a physical component configured to communicate with a special reader via some form of wireless communication like. RFID, NFC etc. Examples of such systems are disclosed in e.g. US 2012/0295703, EP 2749327 and US 2014/256430. It would be generally desirable to provide toy systems that do not require the toy to comprise elements that are capable of communicating with a reader device so as to be able to identity a toy element, and to create its virtual digital representation and associate it with additional digital data.

WO 2011/017393 describes a system that uses computer vision to detect a toy construction model on a special background. In this prior art system, an assembled model is detected on a special background plate with a specific pattern printed on it.

EP 2 714 222 describes a toy construction system for augmented reality,

WO 2018/069269 describes a toy system including scannable tiles including visible, scannable codes. The codes represent in-game powers.

In view of this prior art it remains desirable to provide improved toy systems.

### SUMMARY

Some aspects disclosed herein relate to a computer-implemented method of creating a virtual game environment from a real-world scene, the method comprising:
obtaining a digital three-dimensional representation of a real-world scene, the real-world scene comprising a plurality of physical objects, the digital three-dimensional representation representing a result of at least a partial scan of the real-world scene by a capturing device,
creating, the virtual game environment from the digital three-dimensional representation.

Hence, the real-world scene is used. as a physical model from which the virtual game environment is constructed. The virtual game environment may also be referred to as a virtual game scene.

In particular, a first aspect of the disclosure relates to a method of creating a virtual game environment or virtual game scene, the method comprising the following steps.
1. Selecting one or more physical objects;
2. Providing a physical model of the game environment/scene using the selected physical objects;
3. targeting the physical model with a capturing device, such as a camera;
4. at least partially scanning the physical model with the capturing device to obtain a digital three-dimensional representation of the physical model including information on one or more, e.g. predetermined, physical properties of one or more of the physical objects;
5. converting the digital three-dimensional representation of the physical model into a virtual toy construction model made up of virtual toy construction elements; and
6. defining game-controlling elements in the virtual toy construction model, wherein the game-controlling, elements are defined using the information on the predetermined physical properties, thereby creating the virtual game environment/scene.

In a first step, a user selects one or more physical objects, e.g. according to predetermined physical properties. Typically, the physical objects are everyday items, such as found and readily available in many homes and in particular in the environment of the user. Non-limiting examples for such everyday items may be bottles, books and boxes, cups and colour pencils, pots and pans. dolls, desk top tools, and toy animals. Also toys and toy construction models made of physical toy construction elements may be part of the pool of selected objects.

The objects may be selected according to predetermined physical properties. The physical properties should. be directly detectable by an adequate sensor device. Most preferably, however, the physical properties are optically/visually detectable and suited to be captured by an adequate camera. By predetermined physical properties it is meant that the respective physical properties are associated with a predetermined set of conversion rules for translating the physical properties of the physical objects into virtual properties in a virtual game environment/scene to be created.

The set of conversion rules may be determined beforehand. Preferably, according to some embodiments, at least some of the conversion rules are made available to the user at least during a selection phase. The rules may be made available in any form, e.g. as construction hints in the course of a game, as a sheet, or as retrievable help information. In some embodiments, the conversion rules are static while, in other embodiments, the conversion rules are adaptive. For example, an adaptive conversion rule may depend on detected properties of the real-world scene and/or on one or more other parameters, such as the time of day, a position (e.g. as determined by GPS coordinates) of the camera, a user profile of the user, and/or the like. For example, the process may have stored a set of conversion rules and select one of the conversion rules. The selection may be based on a user-selection and/or based on one or more other parameters, e.g. on detected properties of the real-world scene and/or other parameters as described above.

Preferably, a given physical property and an associated virtual property are ones that are immediately apparent to the user so as to allow for establishing a clearly understandable link between the given physical property and the virtual property to be derived from the given physical property. While an understandable link between a physical property and a virtual property to be derived from this physical property is useful for being able to wilfully create a certain game scene, it is still possible to maintain an element of surprise in the game, by holding back certain details of a virtual implementation that is to be derived from a given physical property. For example, a virtual property may be allowed to evolve during the course of a game, may be made prone to non-playing characters, may spawn resources, or may even have influence on the flow of a game to be played in the game environment/scene.

Typically, the physical properties of the physical objects are one or more of contour/shape, dimensions (length, width and/or height), and colour of the objects or of respective parts of the objects.

Advantageously, the set of conversion rules to be applied depends on the game context/theme within which the game scene is to be created. For, example in one game context/theme red colours may be associated with a lava landscape, and a high, red box may become a square-edged lava mountain. In a different game context all objects may be associated with trees and plants of a virtual forest landscape, and red colours on a physical object would only be associated with red flowers.

In some embodiments, the process selects the set of conversion rules based on one or more recognized objects within the real-world scene. For example, the process may recognize one or more physical objects that are associated. with a predetermined theme, e.g. a tractor, a farmer miniature figure, or a farmhouse may be associated with a farm theme, Responsive to the recognition of one or more objects having associated a theme, the process may select, a set of conversion rules that result in the creation of a virtual game environment matching the theme associated with the recognised objects. Additionally or alternatively, the process may select a matching set of game rules and/or matching game-controlling elements responsive to the recognized object. For example, responsive to recognising the tractor, the farmer miniature figure and/or the farmhouse, the process may select a set of conversion rules that result in the creation of a virtual farming landscape, e.g. including game rules for e.g. a nurturing game and/or game controlling elements including e.g. the growth of crops, movement or other development of virtual farm animals, etc.

Scale related properties such as “high”, “low” or “mid-size” may be defined with respect to a reference dimension determined beforehand. For example, the scale may be determined with reference to the size of a physical miniature figure, which in its corresponding virtual. representation is used as a user-controllable virtual character, e.g. as a playable character for the user in the game. In other embodiments, the scale may be determined with reference to the size of another recognised physical object in the real world scene. In yet other embodiments, the scale may be determined from the dimensions of a base—e.g. a base plate or mat on which the user arranges the physical objects. In yet further embodiments, the scale may be determined using information from a range finder of the camera or another mechanism of determining a camera position relative to the real-world scene.

In a second step the user provides a physical model of the game environment/scene using the selected physical objects. Preferably, the physical model of the game environment/scene is formed by arranging the selected physical objects with respect to each other in. a real-world scene to shape a desired landscape or other environment. Further preferably, the physical objects are arranged within a limited. area, e.g. on a table or a floor space, defining a zone of a given physical size. For example, the physical model may be such that it fits into a cube having edges of no more than 2 in such as no more than 1.5 m, such as no more than

In a third step, the physical model is targeted with a capturing device, e.g. a capturing device including a camera. Preferably, the capturing device is a three-dimensional capturing device, Preferably, the three-dimensional capturing device includes a three-dimensional sensitive camera, such as a depth sensitive camera combining hitch resolution image information with depth information. An example for a depth sensitive camera is the Intel® RealSense™ three-dimensional camera, such as the model F200 available in a developer kit from Intel Corporation. The capturing device communicates with a display showing the scene as seen by the capturing device. The capturing device and the display further communicate with a processor and data storage. Preferably, the capturing device, the processor and/or the display are integrated in a single mobile device, such as a tablet computer, a portable computer or the like. Alternatively, according to some embodiments, a capturing device or a mobile device with a capturing device may communicate with a computer, e.g, by wireless communication with a computing device comprising a processor, data storage and a display. Preferably, additional graphics is shown on the display, such as an augmented reality grid indicating a field of image capture. The additional graphics may be shown as an overlay to the image of the scene shown by the display, wherein the overlay graphics shows what part of the physical model will be captured by the three-dimensional capturing device. Preferably, according to sonic embodiments, the targeting step includes an augmented reality element with a predetermined measuring scale, e.g. indicating on the display a fixed size area to be captured, such as an area of 2 m by 2 m or of one by one meter. The usefulness of the targeting step enhanced by augmented reality may depend on the type of game play for which the game environment/scene is to be created. In certain embodiments, the targeting step enhanced by augmented reality may therefore be omitted. For example, the augmented reality targeting step may be useful when creating a game environment/scene. for a role playing garlic with action and resources, whereas such a step may riot be necessary for the creation of a race track for a racing game.

In a fourth step, the capturing device is moved around. the physical model while capturing a series of images, thereby, at least partially, scanning the physical model to obtain a digital three-dimensional representation of the physical model including information on said physical properties. Most preferably, the information on the physical properties is linked to locations in the digital three-dimensional representation corresponding to the location of the. associated physical objects. A partial scan of a closed object may, for example, be used to create an entrance to the object in the virtual representation thereof, by leaving an opening where the scan is incomplete. The digital three-dimensional representation may e.g. be a point cloud, a three-dimensional mesh or another suitable digital three-dimensional representation of the real-world scene. Preferably the capturing device also captures physical properties such as color, texture anchor transparency of the objects. The digital three-dimensional representation may also be referred to as virtual three-dimensional representation.

In a fifth step, the digital three-dimensional representation the physical model is converted into a virtual toy construction model made up of virtual toy construction elements. To this end, the process may apply the set of conversion rules.

In some embodiments, the virtual toy construction elements correspond to physical toy construction elements in that they are direct representations of the physical toy construction elements having the. same shape and proportions.

The physical toy construction elements may comprise coupling members for detachably interconnecting the toy construction elements with, each other. The coupling members may utilise any suitable mechanism for detachably connecting construction elements with other construction elements. In some embodiments, the coupling members comprise one or more protrusions and one or more cavities, each cavity being adapted to receive at least one of the protrusions in a frictional engagement.

In some embodiments, the toy construction elements may adhere to a set of constraints, e.g. as regards to their shapes and size and/or as regards the positions and orientations of the coupling members and to the. coupling mechanism employed by the coupling members. in some embodiments, at least sonic of the coupling members are adapted to define a direction of connection and to allow interconnection of each construction element with another construction element in a discrete number of predetermined relative orientations relative to the construction element.

Consequently, a large variety of possible building options are available while ensuring interconnectivity of the building elements. The coupling members may be positioned on grid points of a regular grid, and the dimensions of the toy construction elements may be defined as integer multiples of a unit length defined by the regular grid.

The physical toy construction elements may be defined by a predetermined length unit (1 L.U.) in the physical space, wherein linear dimensions of the physical toy construction clement in a Cartesian coordinate system in x-, v-, and z-directions of the physical space are expressed as integer multiples of the predetermined length unit in the physical space (n L.U.'s). Accordingly, the virtual toy construction elements may be defined by a corresponding predetermined length unit, wherein linear dimensions of the virtual toy construction elements in a Cartesian coordinate system in x-, y-. and z-directions of the virtual space are expressed as integer multiples of the corresponding predetermined length unit in the virtual space. Most preferably, the predetermined unit length in the physical space and the corresponding predetermined unit length in the virtual space are the same.

Preferably, the virtual toy construction model is made at a predetermined scale of the physical objects. Further preferably, the predetermined scale is 1:1 within an acceptable precision, such as ±20%, such as ±10%, such as ±5%, or even ±2%. Hence, in some embodiments, the virtual toy construction elements correspond to physical toy construction elements of a toy construction system, and the virtual toy construction model is created such that the relative size of the virtual toy construction elements relative to the virtual toy construction model corresponds to the relative size of the corresponding physical toy construction elements relative to the physical objects.

By building the virtual toy construction model at the same, or at least at a comparable scale, the user may, in a building phase, where he/she selects and maybe arranges/rearranges the physical objects for forming the physical model of the game environment, or even in a game-playing phase perform role playing with a physical miniature figure moving about the real-world scene. A corresponding virtual experience can also be performed with a matching user-controllable character moving around in/on the virtual toy construction model in the virtual world. Thereby, an enhanced interactive experience is achieved where the user experiences a closer link between the play in the physical space and in the virtual space.

In a sixth step, game-controlling elements are defined in the virtual toy construction model. Most preferably, the game controlling elements are defined using the information on the physical properties, thereby creating the virtual game environment/scene. The game controlling elements may comprise active/animated properties attributed to locations in the virtual toy construction model according to the information on the physical properties of the physical objects in the corresponding locations of the physical model. The properties may be allowed to evolve, e.g., by growth, degradation, flow, simulated heating, simulated cooling, changes in color and/or surface texture, movement, spawning of resources and/or non-playing characters, etc. Furthermore, the game-controlling element may be defined such that the evolution needs to be triggered/conditioned by actions in the course of the game, coincidence of a plurality of certain physical properties in the physical model, or the like. The game-controlling element may also be defined to require an interaction with the physical model. For example, the game element may hand out a task to be fulfilled for triggering the release of a certain reward or resource, wherein the task includes building/modifying a physical model with certain physical features characterized by a particular combination of physical properties, and subsequently scanning that new physical model.

A simple example of defining a game controlling element is the use of information about a high red box in the physical model as mentioned above. The red and high box may e.g. cause the occurrence of an edged lava mountain in the virtual world, which may erupt at random times, spawn monsters, that e.g. may compete with the playing character for resources. The lava mountain may further be enhanced by adding predesigned assets, such as lava-bubbles in a very hot part of the mountain, and trees, bushes, or crops on the fruitful slopes of the lava mountain, which may harvested as resources by the playing character. Monsters that the lava region may spawn may have to be defeated as a part of a mission.

Other examples for more advanced game play may involve more complex components in the definition of a game controlling element, such as requiring a plurality of parameters. For example, a physical model building task may require that “water” should meet “ice” ata high altitude, where the user is asked to build and scan a physical model that is half red and half blue.

In some embodiments, defining game-controlling elements in the virtual toy construction model is based on one or more recognised physical objects. In particular, the process may have access to a library of known physical objects, each known physical object having associated with it a three-dimensional digital representation and one or more attributes. Converting the digital three-dimensional representation of the physical model of the game environment/scene into a virtual toy construction model may comprise inserting the three-dimensional digital representation of the recognised physical object into the virtual game environment. In particular, the process may create a virtual object having the one or more attributes associated with the known physical object from the library. Examples of the attributes may include functional attributes, e,g, representing how the virtual object is movable, representing movable parts of the virtual object or other functional features of the virtual object.

The process may thus create a virtual environment as a representation of a modified scene, e.g. as described in greater detail below.

When the virtual game environment/scene is created on the basis of a virtual toy construction model made up of virtual toy construction elements, the virtual game environment/scene may also be modified in the course of the game in a way corresponding to the construction of a physical model using the corresponding physical toy construction elements. Modifications can thus also be made by adding and removing virtual toy construction elements as a part of the game directly in the virtual world. For example, the process may add and/or remove and/or displace virtual toy construction elements responsive to game events such as responsive to user inputs.

Generally, embodiments of the disclosure directly involves and thereby interacts with the environment and physical objects of the user as a part of the game play. Thereby a highly dynamic and interactive game experience is achieved, that not only empowers the user, but also involves and interacts with the user's physical play environment and objects. The particularly interactive nature of the game play enabled by the disclosure stimulates the development of strategy skills, nurturing skills, conflict handling skills, exploration skills, and social skills.

Essentially any type of game play can be enabled by creating a virtual game environment/scene in this manner including, but not limited to, nurture-games, battle type games (player vs. player), racing games, and role playing action resource games. A particular good match for the application of the disclosure is found in games of the role playing action/resource type.

According to yet another aspect, disclosed herein are embodiments of a method for creating a virtual game environment from a real-world scene, the method comprising:
obtaining a digital three-dimensional representation of a real-world scene, the real-world scene comprising a plurality of physical object, the digital three-dimensional representation representing a result of at least a partial scan of the real-world scene by a capturing device;
creating the virtual game environment from the digital three-dimensional representation;
wherein creating the virtual game environment comprises:
recognizing at least one of the physical objects as a known physical object;
creating the virtual game environment responsive to the recognised object.

Recognizing at least one of the physical objects may be based on any suitable object recognition technology. The recognition comprises identifying the physical object as a particular one of a set of known objects. The recognition may be based on identification information communicated by the physical object and/or by identification information that may otherwise be acquired from the physical object.

In some embodiments, the recognition may be based on the scanning of the real-world scene. For example, the recognition may be based on the processing of one or more captured images of the real-world scene, e.g. as described in WO 2016/075081 or using another suitable object recognition process. In some embodiments, the physical object may comprise a visible marker such as an augmented reality tag, a QR code, or another marker detectable by scanning the real world scene. In other embodiments, the recognition of the physical object may be based on other detection and recognition technology, e.g. based on an REID tag included in the physical object, a radio frequency transmitter such as a Bluetooth transmitter, or another suitable detection and recognition technology.

The digital three-dimensional representation may comprise a plurality of geometry elements that together define a surface geometry and/or a volume geometry of the virtual environment. The geometry elements may e.g. be a plurality of surface elements forming a mesh of surface elements, e.g. a mesh of polygons, such as triangles. In other embodiments the geometry elements may be volume elements, also referred to as voxels. In some embodiments, the geometry elements may be virtual construction elements of a virtual toy construction system. Creating may be as defined in a method according to one of the other aspects.

In some embodiments, the process may have access to a library of known physical objects. The library may be stored on a computer readable medium, e.g, locally on a processing device executing the method or it may be stored at a remote location and accessible to the processing device via e.g. a computer network such as the internet. The library may comprise additional information associated with each known physical object such as attributes associated with the physical object, a digital three-dimensional representation of the physical object for use in a digital environment, a theme associated with the known physical object and/or other properties of the physical object. Creating the virtual game environment responsive to the recognised object may thus be based on this additional information.

According to some embodiments, creating the virtual game environment responsive to the recognised object comprises:
creating a virtual object associated with the recognised physical object;
creating the virtual game environment as a representation of a modified scene, the modified scene corresponding to the real-world scene with the recognised physical object being removed; and
optionally placing a representation of the created virtual object in the created virtual game environment.

Hence, in some embodiments, the process creates a virtual environment with a created virtual object placed within the virtual environment. In some embodiments, a part of the digital three-dimensional representation represents the recognised physical object. Accordingly a part of a virtual environment created based on the digital three-dimensional representation represents the recognised physical object. In some embodiments, creating the virtual game environment as a representation of a modified scene comprises
detecting a part of the digital three-dimensional representation or of the virtual game environment associated with the recognised physical object; and
replacing the detected part by a modified part representing a modified scene without the recognised object.

The process may thus create a virtual environment as a representation of a modified scene, the modified scene corresponding to the real-world scene with the recognised physical object being removed. For example, the process may determine a subset of virtual toy construction elements or of other geometry elements of the virtual game environment that correspond to the recognised object. The process may then replace the determined subset with the stored digital three-dimensional representation of the recognised physical object. Alternatively, the process may determine a subset of geometry elements (e.g. surface elements of a three-dimensional mesh) of the digital three-dimensional representation obtained from the scanning process that correspond to the recognised object. The process may then create a modified digital three-dimensional representation where the detected part has been removed and, optionally, replaced by other surface elements. Hence, the modified part may be created from a part of the digital three-dimensional representation in a proximity of the detected part, e.g. surrounding the detected part., e,g, from an interpolation of parts surrounding the detected part. For example, the process may create surface elements based on surface elements in a proximity of the detected part so as to fill a hole in the representation created by the removal of the detected. part.

The process may then create the game environment from the modified digital three-dimensional representation.

The virtual object may be a part of the virtual environment or it may be a virtual object that is separate from the virtual environment but that may be placed into the virtual environment and be able to move about the created virtual environment and/or otherwise interact with the virtual environment. Such movement and/or other interaction may be controlled based on game. events e.g. based on user inputs, in particular, the virtual object may be a player character or other user-controlled character or it may be a non-player character.

In some embodiments, the recognised physical object may be a toy construction model constructed from a plurality of construction elements. The process may have access to a library of known virtual toy construction models. Accordingly, the virtual object may be represented based on a more accurate digital three-dimensional representation of the individual construction elements than may expediently be achievable from a conventional three-dimensional reconstruction pipeline. Moreover, the virtual toy construction model may have predetermined functionalities associated with it. For example, a wheel may be animated to rotate, a door may be animated to be opened, a fire hose may be animated to eject water, a canon may be animated to discharge projectiles, etc.

According to some embodiments, creating the virtual game environment responsive to the recognised physical object may comprise creating at least a part of the game environment other than the part representing the recognised physical object responsive to the recognised physical object. In particular the part of the game environment other than the part representing the recognised physical object may be created to have one or more game-controlling elements and/or one or more other attributes based on a property of the recognised physical object. In some embodiments, the process creates or modifies the part of the game environment ther than the part representing the recognised physical object such that the part represents a theme associated with the recognised physical object.

The part of the game environment other than the part representing the recognised physical object may be a part of the game environment that is located within a proximity of the part representing the recognised physical object. The size of the proximity may be predetermined, controllable by the user, randomly selected or it may be determined based on detected properties of the real world scene, e.g, a size of the recognised physical object. The recognition of multiple physical objects may result in respective parts of the virtual game environment to be modified accordingly The deuce of modification of a part of the game environment may depend on a distance from the recognised physical object, e.g, such that parts that are farther away from the recognised physical object are modified to a lesser degree.

According to one aspect, disclosed herein are embodiments of a method for controlling digital game play in a virtual environment. Embodiments of the method comprise performing the steps of an embodiment of a method to creating a virtual game environment disclosed herein and controlling digital game play in the created virtual game environment. Controlling digital game play may comprise controlling one or more virtual objects moving about and/or otherwise interacting with the virtual game environment as described herein.

Some embodiments of the method disclosed herein create a voxel-based representation of the virtual game environment. However, a scanning process often results in a surface representation of the real-world scene from which a voxel-based representation should. be created, it is thus generally desirable to provide an efficient process for creating such a representation. For example, a process of creating a virtual toy model from a digital three-dimensional representation of a scanned real-world scene may obtain the digital three-dimensional representation of a surface of the real-world scene. The process may then create a voxel-based representation of the real-world scene and then create a virtual toy construction model from the voxel-based representation, e.g. such that each virtual toy construction element of the virtual toy construction model corresponds to a single voxel or to a plurality of voxels of the voxel-based representation.

Accordingly, another aspect of the disclosure relates to a computer implemented method of creating a digital three-dimensional representation of an object, the method comprising:
receiving a digital three-dimensional representation of a surface of the object, the digital three-dimensional representation of the surface comprising at least one surface element, the surface element comprising a boundary and a surface area surrounded by said boundary;
mapping the surface onto plurality of voxels; and
creating the digital three-dimensional representation of the object from the identified voxels

wherein mapping comprises:
for each surface element, defining a plurality of points within said surface element, wherein at least a subset of said plurality of points lie within the surface area of the surface element;
mapping each of the plurality of points on a corresponding voxel.

Mapping individual points into voxel space and, in particular, identifying a voxel into which a given point falls, is a computationally efficient task. For example, the coordinates of the point relative to a coordinate system may be divided by the linear extent of a voxel along the respective axes of the coordinate system. An integer part of the division is thus indicative of an index of the corresponding voxel in voxel space.

The plurality of points are defined such that not all of them are positioned ion the boundary. When the plurality of points are distributed across the surface element, identifying, for each point, which voxel the point falls into has been found to provide a computationally efficient and sufficiently accurate approximation of the set of voxels that intersect the surface element, in particular when the points are distributed sufficiently densely relative to the size of the voxels.

The voxels may have a box shape, such as a cubic shape or they may have another suitable shape, in particular a representation where the yowls together cover the entire volume without voids between voxels and where the voxels do not overlap. The voxels of a voxel space have typically all the same shape and size. The linear extent of each voxel along the respective coordinate axes of a coordinate system may be the same or different for the different coordinate axes. For example, when the voxels are box shaped, the edges of the box may be aligned with the respective axes of a coordinate system, e.g. a Cartesian coordinate system. When the box is a cube, the linear extent of the voxel is the same along each of the axes; otherwise the linear extent is different for one or all three axes. In any event, a minimum linear extent of the voxels may be defined. in the case of cubic voxels, the minimum linear extent is the length of the edges of the cube. In the case of box shaped voxels, the minimum extent is the length of the shortest edge of the box. In some embodiments, the minimum linear extend of the voxels is defined with reference to a predetermined length unit associated with the corresponding virtual toy construction elements, e.g. equal to one such length unit or as an integer ratio thereof, e.g. as ½, ⅓, or the like.

In some embodiments the plurality of points define a triangular planar grid having the plurality of points as grid points of the triangular planar grid where each triangle of the grid has a smallest edge no larger than the minimum linear extent of the voxels and a largest edge no larger than twice the minimum linear extent. In particular, in one embodiment, the largest edge is no larger than twice the minimum linear extent and the remaining edges are no larger than the minimum linear extent. The triangular grid may be a regular or an irregular grid: in particular, all triangles may be identical or they may be different from each other. In some embodiments, the surface element is thus divided into such triangles with the plurality of points forming the corners of the triangles and the triangular grid filling the entire surface element.

The surface element may be za planar surface element, e.g. a polygon such as a triangle. The triangular planar grid is defined in the plane defined by the surface element which may also be a triangle.

In some embodiments, the surface element is a triangle and the plurality of points are defined by:
selecting a first sequence of points on a first edge of the triangle. For example, this may be done by selecting two corners of the triangle and by defining the first sequence of points along the edge connecting the two selected corners, e.g. by defining a sequence of intermediate points lying between the comers such that an initial intermediate point of the sequence has a predetermined distance from one of the corners of the triangle and such that each subsequent intermediate point of the sequence has the same predetermined distance to the previous intermediate point of the sequence. For example, the distance may be equal to the minimum linear extent of the voxels; or it may be the largest length, no larger than the minimum extent of the voxels, by which the first edge is divisible. The first sequence of points is then defined to comprise the sequence of intermediate points. One or both of the corners may further be included in the first sequence.
For each point of the first sequence defining an associated straight line connecting said point and the corner of the triangle that is opposite the first edge; and
For each associated straight line, selecting a sequence of further points on said straight line. For example, the sequence of further points may be selected in the same manner as the first sequence of points, with the end points of the associated straight, i.e. by defining a sequence of intermediate points between the endpoints of the associated straight line and, optionally, by including one or both end points of the associated straight line.

In some embodiments the surface element has one or more surface attribute values of one or more surface attributes associated with it, Examples of attributes include a surface color, a surface texture, a surface transparency, etc. In particular, in some embodiments, the attributes are associated with the surface element as a whole; in other embodiments, respective attributes may be associated. with different parts of the surface element. For example, when the boundary of the surface element is a polygon, each corner of the polygon may have one or more attribute values associated with it.

In some embodiments, the method further comprises associating one or more voxel attribute values to each of the voxels of the digital three-dimensional representation; wherein the at least one voxel attribute value is determined from the surface attribute values of one of the surface elements. To this end, mapping each of the plurality of points to a voxel comprises determining a voxel attribute value from. the one or more surface attribute values of the surface element. For example, when the surface element is a polygon, and each corner of a polygon has a surface attribute value of an attribute associated with it; determining the voxel attribute value of a voxel mapped to a point may comprise computing a weighted combination, e.g. a weighted average, of the surface attribute values of the respective corners; the weighted combination may be computed based on respective distances between said point and the corners of the polygon.

In some embodiments, one or more of the attributes may only have a set of discrete values. For example, in some embodiments, a color may only have one of a predetermined set of color values, e.g, colors of a predetermined color palette. A restriction to a predetermined set of discrete colors may e.g. be desirable when creating digital three-dimensional representations of physical products that only exist in at set of predetermined colors. Nevertheless, the process of creating a digital three-dimensional representation may receive one or more input colors, e.g. one or more colors associated with a surface element or a voxel. The input color may e.g. result from a scanning process or be computed as a weighted average of multiple input colors, e.g. as described above. Consequently, the input color may not necessarily be one of the colors included in the predetermined set. Therefore, it may be necessary to determine a closest color among a predetermined set of colors, i.e. a color from the set that is closest to the input color.

Accordingly, according to one aspect, disclosed herein are embodiments of a computer implemented method for identifying a target color of a predetermined set of colors, the target color representing an input color; the method comprising:
representing the input color and each color of the predetermined set of colors in a three-dimensional color space, wherein all colors of the set of colors lie within a ball having an origin and a radius;
determining a current candidate. color from the predetermined set of colors;
analysing a subset of the predetermined set of colors to identify an updated candidate color from the subset of the predetermined set of colors wherein the updated candidate color has a smaller distance to the input color than the current candidate color and wherein the subset of the predetermined set of colors only comprises colors of the predetermined set of colors that have a distance from the origin which is no larger than a sum of the distance between the input color and the origin and the distance between the input color and the current candidate color. The distances are computed based on a suitable distance measure in the three-dimensional color space. In an RGB space he distance may be defined as a Euclidean distance. The sum of distances is a scalar sum of the distances.

Hence, by limiting the radians of the search area in color space, the time required for a processing device to search the color space is considerably reduced. To this end, the predetermined set of colors may be represented in a data structure where each color of the predetermined set has associated with it its distance from the origin, in some embodiments, the set may even. he ordered according to the distances of the respective colors from the origin. This reduction in computing time is particularly useful when the determination of a closest color needs to be performed for each surface element and/or for each voxel of a digital three-dimensional representation.

In some embodiments, the color space is and RGB color space, but other representations of colors may be used as well.

Embodiments of the methods described herein may be used as part of a pipeline of sub-processes for creating a digital three-dimensional representation of one or more real-world objects or of a real-world scene comprising multiple objects, e.g, by scanning the object or scene, processing the scan data, and creating a digital three-dimensional representation of the object or scene. The created digital three-dimensional representation may be used by a computer for displaying a virtual game environment and/or a virtual object e.g. a virtual object within a virtual environment such as a virtual world. The virtual object may be a virtual character or item within a digital game, e.g. a user-controllable virtual character (such as a player character) or a user-controllable vehicle or other user-controllable virtual object.

According to a further aspect, embodiments are disclosed of a method for creating a virtual toy construction model from a voxel representation of an object. Embodiments of the method may comprise the steps of one or more of the methods according to one of the other aspects disclosed herein. Virtual toy construction models are known from e.g. U.S. Pat. No. 7,439, 972. In particular, a virtual toy construction model may be a virtual counterpart of a real-world toy construction model that is constructed from, and comprises, a plurality of physical toy construction elements, in particular elements of different size and/or shape and/or color, that can be mutually interconnected so as to form a physical toy construction model constructed from the physical toy construction elements.

A virtual toy construction system comprises virtual toy construction elements that can be combined. with each other in a virtual environment so as to form a virtual toy construction model. Each virtual toy construction element may be represented by a digital three-dimensional representation of said element, where the digital three-dimensional representation is indicative of the shape and size of the element as well as further element properties, such as a color, connectivity properties, a mass, a virtual function, and/or the like. The connectivity properties may be indicative of how a construction elements can be connected to other toy construction elements, e.g as described in U.S. Pat. No. 7,439, 972.

A virtual toy construction model comprises a plurality of one or more virtual toy construction elements that together form the virtual toy construction model. In some embodiments, a virtual toy construction system may impose constraints as to how the virtual toy construction elements may be positioned relative to each other within a model. These constraints may include a constraint that two toy construction elements may not occupy the same volume of a virtual space. Additional constraints may impose rules as to which toy construction elements may be placed next to each other and/or as to the possible relative positions and/or orientations at which two toy construction elements can be placed next to each other. For example, these constraints may model the construction rules and constraints of a corresponding real-world toy construction system.

The present disclosure relates to different aspects including the methods described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

According to a further aspect of the disclosure an interactive game system includes a capturing device, a display adapted to show at least image data captured by the capturing device, data storage adapted to store captured data, and programming instructions for the processor, and a processor programmed to directly or indirectly interact with the capturing device or act on the data received directly or indirectly from the capturing device and perform virtual processing steps of one or more of the above mentioned methods.

In particular, according to one aspect, an interactive game system is configured to:
receive scan data from the capturing device, the scan data being indicative of a physical model of a game environment/scene, the physical model comprising one or more physical objects;
create a digital three-dimensional representation of the physical model, the digital three-dimensional representation including information about one or more physical properties of one or more of the physical objects;
convert the digital three-dimensional representation of the physical model into a virtual toy construction model made up of virtual toy construction elements; and
define game-controlling elements in the virtual toy construction model, wherein the game-controlling elements are defined using the information on the physical properties, thereby creating the virtual game environment/scene.

According to another aspect, an interactive game system is configured to:
receive scan data from the capturing device, the. scan data being indicative of a physical model of a game environment scene, the physical model comprising one or more physical objects;
create a digital three-dimensional representation of the physical model, the digital three-dimensional representation including information about one or more physical properties of one or more of the physical objects;
create a virtual game environment from the digital three-dimensional representation; wherein creating the virtual game environment comprises:
   recognizing at least one of the physical objects as a known physical object:
   creating the virtual game environment responsive to the recognised object.

The interactive game system may comprise a storage device having stored thereon a library of known physical object as described herein.

Preferably, the capturing device is adapted to provide image data from which three-dimensional scan data can be constructed when moved around a physical model made up of one or more physical objects. Furthermore, the capturing device is adapted to provide data from which physical properties can be derived. Preferably, such physical properties include color and/or linear dimensions that are scaled in absolute and/or relative dimensions. Advantageously, the capturing device is a three-dimensional imaging camera, a ranging camera and/or a depth sensitive camera as mentioned above. The processor is adapted and programmed to receive the image data and any further information about the physical properties captured from the physical model, and process this data to convert the data into a virtual mesh representation of the physical model including the further information, further process the data to convert the mesh representation into a virtual toy construction model made up of virtual toy construction elements, processing the data to define game segments using the virtual toy construction model and the further information, and finally output a virtual game environment/scene. As described herein, the conversion of the mesh representation into a virtual toy construction model may include a process of converting a mesh representation into a voxel representation and converting the voxel representation into a virtual toy construction model.

In an advantageous embodiment, the display communicates with the processor and/or capturing device to provide an augmented reality overlay to the image data shown on the display for targeting the physical model and/or during scanning of the physical model.

In a particularly advantageous embodiment, the capturing device, data storage, processor and display are integrated in a single mobile device, such as a tablet computer, a portable computer, or a mobile phone. Thereby providing a unified game play experience, which may be of particular importance for providing games to technically less experienced users.

The present disclosure further relates to a data processing system configured to perform the steps of an embodiment of one or more of the methods disclosed herein. To this end, the data processing system may comprise or be connectable to a computer readable medium from which a computer program can be loaded into a processor, such as a CPU, for execution. The computer readable medium may thus have stored thereon program code means adapted to cause, when executed on the data processing system, the data processing system to perform the steps of the method described herein. The data processing system may comprise a suitably programmed computer such as a portable computer, a tablet computer, a smartphone, a PDA or another programmable computing device having a graphical user interface. In some embodiments, the data processing system may include a client system, e.g. including a camera and a user interface, and a host system which may create and control a virtual environment. The client and the host system may be connected via a suitable communications network such as the interne. Embodiments of the data processing system may implement an interactive game system as described herein.

Generally, here and in the following the term processor is intended to comprise any circuit and/or device and/or system suitably adapted to perform the functions described herein. In particular, the above term comprises general or special purpose programmable microprocessors, such as a central processing unit (CPU) of a computer or other data processing system, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. The processor may be implemented as a plurality of processing units.

Some embodiments of the data processing system include a capturing device such as an image capturing device, e.g, a camera, e.g. a video camera, or any other suitable device for obtaining one or more images of a real-world scene or other real-world object. Other embodiments may be configured to generate a digital three-dimensional representation of the real-world scene and; or retrieve a previously generated digital three-dimensional representation.

The present disclosure further relates to a computer program product comprising program code means adapted to cause, when executed on a data processing system, said data processing system to perform the steps of one or more of the methods described herein.

The computer program product may be provided as a computer readable medium. Generally, examples of a computer readable medium include a CD-ROM, DVD, optical disc, memory card, flash memory, magnetic storage device, floppy disk, hard disk, etc. In other embodiments, a computer program product may be provided as a downloadable software package, e.g. on a web server for download over the internet or other computer or communication network, or an application for download to a mobile device from an App store.

Game Play Loop

According to a further aspect, the disclosure relates to a method of playing an interactive game including performing the above method for creating a virtual game environment scene.

Preferably, the method of playing an interactive game is arrange in a cyclic manner, each cycle comprising the steps of
Creating a virtual game environment/scene from a game enabled virtual toy construction model using a three-dimensional scan of selected physical objects as described herein;
playing One or more game segments in the. virtual game environments and
in response to the outcome of the game play, initiating a new cycle.

According to some embodiments, the creation of the virtual game environment is a step separate from the actual virtual game play involving virtual objects moving about and/or otherwise interacting with the created virtual game environment. In particular, the user may use a previously created virtual environment to engage in virtual game play without the need of the physical model of the virtual environment still being present or still being targeted with a capture device. This is in contrast to some real-time systems which augment real-time images with computer generated graphics during the game play. At least in some embodiments of the present disclosure, the virtual game environment is solely represented by a computer generated digital representation that may be stored on a data processing system for later use.

According to a further aspect, the disclosure relates to a cyclic interactive game system for playing an interactive game including a device adapted for performing the above method for creating a virtual game environment/scene as described with respect to the interactive game system mentioned above.

Preferably, the cyclic interactive game system is arranged and programmed for playing an interactive game in a cyclic manner, each cycle comprising the steps of
Creating a virtual game environment cone of a game enabled virtual toy construction model using a three-dimensional scan of selected physical Objects as described herein;
playing one or more game segments in the virtual game environment, scene; and
in response to the outcome of the game play, initiating a new cycle.

Advantageously, the outcome of the game play may be remunerated by an award directly, or indirectly, e.g. via in-game currency and/or user input, unlocking new game levels, new tools, new themes, new tasks, new playing and/or non-playing characters, new avatars, new skills, and/or new powers, or the like.

By arranging the game play system/method in a cyclic manner, a contained and constantly evolving game play experience is provided, which is particularly interactive, and further stimulates the development of strategy skills, nurturing skills, conflict handling skills, exploration skills, and social skills.

Since physical objects in the user's physical environment are interlinked with the virtual world, the user experiences that changes and choices applied in the physical world matter in the virtual game play. Thereby the user's physical game play and the virtual game play are linked to ether in a continued and dynamically evolving manner.

Physical Playable Characters made of Toy Construction Elements

According to a further advantageous embodiment, the interactive or cyclic interactive game system further includes a physical playable character provided as a toy construction model of the playing character, wherein the virtual game play is performed through a virtual playable character in the form of a virtual toy construction model representing the physical playing character in the virtual world. Advantageously, the physical playing character may be equipped with physical tool models representing specific tools, skills, and/or powers that are then unlocked and represented in a corresponding manner in the virtual playable character. Thereby the interactive experience of interlinked physical and virtual game play experience is further enhanced.

The physical playable character may be entered and unlocked in the virtual game play by any suitable method, such as scanning and recognizing the physical playable character, e.g. as described herein. In some embodiments, the process may perform a look-up in a library of known/available/certified playable characters, and/or recognize and identify physical features and/or toy construction elements or known functionality that are present in the physical playable character, and construct a corresponding virtual playable character. Other ways of unlocking a virtual playable character and linking the virtual playable character to a corresponding physical playable character including toy construction elements representing tools/skills/powers available to the playable character may be conceived, such as scanning an identification tag, entering codes for identifying and/or unlocking the playable character and its tools/skills/powers in a user dialog interface, or the like.

In accordance with one aspect, disclosed herein are embodiments of a toy system. The toy system comprises: a plurality of toy construction elements, an image capturing device and a processor. The image capturing device is operable to capture one or more images of a toy construction model constructed from the toy construction elements. The processor is configured to:
execute a digital game, the digital game comprising computer executable code configured to cause the processor to provide a digital play experience;
receive an unlock code indicative of one or more virtual objects;
responsive to receiving the unlock code, unlock the one or more virtual objects associated with said received unlock code for use in the digital play experience, each virtual object being associated with a respective one of said toy construction elements or with a respective toy construction model constructed from the toy construction elements;
receive one ter t care images captured by said image capturing device;
recognise one or more toy construction elements d/or toy construction models within the one or more images;
responsive to recognising a first toy construction element or a first toy construction model associated with a first one of the unlocked virtual objects, provide a digital play experience involving said first unlocked virtual object.

Hence, the toy system allows the user to interact with the digital game by presenting one or more toy construction elements and/or thy construction models to the toy system such that the image capturing device captures one or more images of the one or more toy construction elements and/or toy construction models and the processor recognises at least a first toy construction element or a first toy construction model. If a first virtual object associated with the recognized first toy construction element or first toy construction model has previously been unlocked by means of a corresponding unlock code, the toy system provides a play experience involving the first virtual object associated with the recognized first toy construction element or first toy construction model.

Hence, the toy construction elements themselves do not need to be provided with recognisable unlock codes, thus allowing the user to use conventional toy construction elements to construct the toy construction model without requiring toy construction elements that are specifically adapted for the toy system. Nevertheless, the toy system provides an authentication mechanism that only provides access to the virtual objects subject to proper authentication by means of an unlock code. The processor may be configured to determine whether the received unlock code is an authentic unlock code.

Moreover, as embodiments of the process only need to recognize toy construction models that are associated with already unlocked virtual objects, the recognition task is simplified, since the number of different toy construction models to be recognized and distinguished from each other is limited to a set of known toy construction models.

The unlock code may have various forms, e.g. a barcode, QR code or other visually recognisable code. In other embodiments, the unlock code may be provided as an RFID tag or other electronic tag that can he read by a data processing system. Yet alternatively, the unlock code may be provided as a code to be manually entered by a user, e.g. as a sequence of alphanumeric symbols or in another suitable manner. In some embodiments, the unlock code may be provided as a combination of two or more of the above and/or in a different manner.

The unlock code may be provided as a physical item, e.g. a token or card on which a machine readable and/or human readable code is printed or into which an electronic tag is incorporated. The physical item may be a toy constriction element that includes coupling members for attaching the physical item to other toy construction elements of the set. Alternatively the physical item may be a physical item different from a toy construction element of the toy construction elements, i.e. without coupling members compatible with the toy construction system. The unlock code may also be provided as a part of the wrapping of a toy construction set, e.g. printed on the inside of a container, or otherwise obstructed from access prior to opening the wrapping.

The unlock code may be a unique code. The unlock code may be a one-time code (or otherwise limited use code), i.e. the processor may be configured to determine whether the received unlock code has previously been used and unlock the virtual object only, if the code has not previously been used. Accordingly, unlocking the virtual object may comprise marking the unlock code as use/expired.

The determination as to whether the unlock code has previously been used may be done in a variety of ways. For example, when the unlock code is provided as an electronic tag, the tag may include a rewritable memory and the processor may be configured to delete the unlock code from the tag or otherwise mark the unlock code as used/expired. Alternatively, the toy system may include a central repository of authentic unlock codes, e.g. maintained by a server computer. The processor may be communicatively connectable to the repository, e.g. via a suitable communications network such as the internet. Responsive to receipt of an unlock code, the processor may request authentication of the received unlock code by the repository. The repository may respond to the request with an indication as to whether the unlock code is authentic and/or whether the unlock code has already been used. The repository may also communicate to the processor which one or more virtual objects are associated with the unlock code. Upon unlocking the corresponding virtual objects, the unlock code may be marked as used in the repository (e.g. responsive to the initial request or responsive to a subsequent indication by the processor that the corresponding virtual object has been successfully unlocked).

Unlocking the virtual object may comprise unlocking the virtual object in an instance of the digital game, e.g. on a particular data processing device and/or for a given user. To this end, the unlocked virtual object may be associated with a user ID which may be stored locally on a processing device and/or in a central user repository. In some embodiments, the receipt of the unlock code may be performed as part of the digital game, in particular while the digital game is being executed, e.g. as part of the digital play experience. In some embodiments, the processor may receive the unlock code prior to providing the digital play experience, e.g. during an initial part of the digital game or even prior to executing the digital game. e.g. under control of a computer program different from the digital game.

In embodiments where the unlock code is provided as an electronic tag, such as an RFID tang, the toy system comprises a suitable electronic tag reader, e.g. an RFID reader. In embodiments where the unlock code is provided as a visually detectable code, the toy system comprises a suitable visual tag reader, e.g. a camera or other image capture device, in particular, the same image capture device may be used for reading the unlock code and for recognizing the toy construction elements and/or models. It will be appreciated that these two operations may typically be performed in separate steps and based on different captured images.

Many types of digital play experiences, in particular digital games, can be enhanced by the unlocking and recognition process described herein, including, but not limited to, nurture games, battle type games (player vs. player or player vs. computer), racing games, and role playing action/resource games, virtual construction games, massive multiplayer online games, strategy games, augmented reality games, games on mobile devices, cogames allowing users to collect digital items, etc. In some embodiments the digital game comprises computer executable code configured to cause the processor to control at least one virtual object. Examples of virtual objects include virtual characters, such as a virtual player character that is controlled by the toy system in direct response to user inputs, or a non-player character that is controlled by the toy system based on the rules of the game. Other examples of virtual objects include inanimate objects, such as accessories that can be used by virtual characters, e.g. weapons, vehicles, clothing, armour, food, in-game currency or other types of in-game resources, etc. Accordingly, the digital game may be of the type where the user controls a virtual object such as a virtual character in a virtual game environment. Alternatively or additionally, the digital game may provide a different form of play experience, e.g. a digital nurturing game, a digital game where the user may construct digital worlds or other structures from multiple virtual objects, a strategic game. a play experience where the user collects virtual objects, a social platform, and/or the like.

Generally, the virtual objects may be virtual characters or other animate or inanimate virtual items, such a vehicles, houses, structures, accessories such as weapons, clothing, jewellery, tools, etc. to be used by virtual characters, etc. Generally, a virtual object may represent any type of game asset.

An unlock code may represent a single virtual object or multiple virtual objects. For example, a toy construction set may comprise (e.g. provided in a box or other container) a plurality of toy construction elements from which one or more toy construction models can be constructed. The toy construction set may further comprise one or more unlock codes, e.g. accommodated inside the container. In some embodiments, a single unlock code may be provided which unlocks multiple virtual objects, e.g. associated with respective toy construction elements of the set and/or with respective toy construction models that can be constructed from the toy construction elements included in the toy construction set. In other embodiments, the toy construction set may comprise multiple unlock codes each for unlocking respective ones of the toy construction elements and/or models.

The recognition of the toy construction elements and/or models may be performed using known methods from the field of computer vision, e,g. as described in WO 2016/075081.

In some, embodiments, unlocking a virtual object may not automatically assign or activate the virtual object but merely make the virtual object available to the user of the digital game, e,g. such that the user can subsequently select, assign or activate the virtual object. To this end, the digital game may create a representation of the virtual object and/or add the virtual object to a collection of available virtual objects.

The unlocked first virtual object has a visual appearance that may resemble the first toy construction element or model with which the first virtual object is associated. The visual appearance may be predetermined, i.e. the first virtual object may resemble a predetermined toy construction model or predetermined toy construction element.

In alternative embodiments, responsive to receiving the unlock code, unlocking the one or more virtual objects may comprise associating a visual appearance to the unlocked virtual object. To this end, in some embodiments, the system may allow the user to capture one or more images of a toy construction model whose visual appearance is to be associated with the unlocked virtual object. Hence, the user may customise the visual appearance of the unlocked virtual object. In particular, the processor may recognise one of a set of available toy construction models and apply the corresponding visual appearance to the unlocked virtual object.

For the purpose of the present description, a toy construction model is a coherent structure constructed from two or more toy construction elements. A toy construction element is a single coherent element that cannot be disassembled in a non-destructive manner into smaller toy construction elements of the toy construction system. A toy construction model or toy construction element may be part of a larger structure, e.g. a larger toy construction model, while still being individually recognizable. A toy construction model or element recognized or recognizable by the processor in a captured image refers to a toy construction model or element that is individually recognized or recognizable, regardless as to whether the toy construction model or element is captured in the image on its own or as part of a larger toy construction model. For example, the processor may be configured to recognize partial toy construction models at different stages of construction. So as the user builds e.g. a wall that will be part of a bigger building the processor may be operable to recognize the wall as a partial toy construction model and the complete building as the completed toy construction model.

In any event, the received one or more images within which the processor recognises one or more toy construction elements anchor toy construction models may depict a composite toy construction model constructed from at least a first toy construction model and a second toy construction model or a composite toy construction model constructed from a first toy construction model and an additional first toy construction element. The first and second toy construction models may be interconnected with each other directly or indirectly—via further toy construction elements—so as to form a coherent composite toy construction model. Similarly, the first toy construction model and the additional first toy construction element may be interconnected with each other directly or indirectly—via further toy construction elements—so as to form a coherent composite toy construction model. A composite toy construction model is thus formed as a coherent structure formed from two or more interconnected individual toy construction models and/or from one or individual toy construction models interconnected with one or more additional toy construction elements. Here the terms individual toy construction models and additional toy construction elements refer to toy construction models or elements that are individually recognisable by the processor of the toy system.

For example, the composite toy construction model may comprise a vehicle constructed from a plurality of toy construction elements and a figurine riding or driving the vehicle where the figurine itself is constructed from multiple toy construction elements. In another example, the composite toy construction model comprises a figurine constructed from multiple toy construction elements and the figurine may carry a weapon which may be formed as a single toy construction element or it may itself be constructed from multiple toy construction elements.

Recognising one or more toy construction elements and/or toy construction models within the one or more images may thus comprise recognising each of the first and second toy construction models included in the composite toy construction model and/or recognising each of the first toy construction model and the first toy construction element included in the composite toy construction model.

Generally, in some embodiments, the process may be configured to recognize multiple toy construction models in the same image, e.g. separate toy construction models placed next to each other or interconnected toy construction models forming a composite toy construction model.

The processor may thus be configured, responsive to recognising the first and second toy construction models, where the first toy construction model is associated with a first unlocked virtual object and the second toy construction model is associated with a second unlocked virtual object, to provide a digital play experience involving said first and second unlocked virtual objects, in particular such that the first and second virtual objects interact with each other. For example, the play experience may involve a composite virtual object formed as a combination of the first and second virtual objects, e.g. as a vehicle with a driver/rider.

Similarly, responsive to recognising the first toy construction model and the first additional toy construction element, where the first toy construction model is associated with a first unlocked virtual object and the first additional toy construction element is associated with a second unlocked virtual object, the processor may be configured to provide a digital play experience involving said first and second unlocked virtual objects, in particular such that the first and second virtual objects interact with each other. For example, the play experience may involve a composite virtual object formed as a combination of the first and second virtual objects, e.g. as a virtual character carrying a weapon or other accessory.

Hence, the user may select one or several, e.g. a combination of the unlocked virtual objects by construction and capturing images of corresponding toy construction models and/or by capturing images of corresponding toy construction elements, In some embodiments, this selection may be performed a single time while, in other embodiments, the toy system may allow a user to repeatedly select different virtual objects and/or different combination of virtual objects to be included in the digital play experience.

In some embodiments, the multiple, individually recognizable toy construction models and/or additional toy construction elements forming a composite toy construction model may be interconnected in different spatial configurations relative to each other. For example a figurine may be positioned in or on a vehicle in different riding positions. The processor may be configured to not only recognise the individual toy construction models and/or elements, but also their spatial configuration. The processor may then modify the provided play experience responsive to the recognised spatial configuration. For example, a weapon carried by a figurine may provide different in-game attributes, e.g. powers, depending on how the weapon is carried by the figurine, e.g. whether it is carried in the left or right hand.

The digital play experience involving the selected virtual object or objects may have a variety of forms. For example, the digital play experience involving the selected virtual object or objects may be a digital game where the user controls the thus selected virtual object or combination of objects. in other embodiments, the digital play experience may allow a user to arrange the select virtual object or objects within a digital environment, e.g.. a digital scene, or to modify the selected virtual object(s), e.g. to decorate the virtual object(s) or to use the selected virtual object(s) as part of a digital construction environment, to trade selected virtual objects with other users of an online play experience or to otherwise interact with virtual object(s) selected by other users.

Generally, in some embodiments, each of the toy construction elements comprises one or more coupling members configured for detachably attaching the toy construction element to one or more other toy construction elements of the toy construction system. To this end the toy construction elements may comprise mating coupling members configured for mechanical and detachable interconnection with the coupling members of other toy construction elements, e.g. in frictional and/or interlocking engagement. In some embodiments, the coupling members are compatible with the toy construction system.

In some embodiments, the image capturing device is a camera, such as a digital camera, e.g. a conventional digital camera. The image capturing device may be a built-in camera of a portable processing device. Generally, examples of portable processing devices include a tablet computer, a laptop computer, a smartphone or other mobile device. In some embodiments, the image capturing device comprises a three-dimensional capturing device such as a three-dimensional sensitive camera, e.g. a depth sensitive camera combining high resolution image information with depth information. An example of a depth sensitive camera is the Intel

RealSense™ three-dimensional camera, such as the model F200 available in a developer kit from Intel Corporation. The image capturing device may be operable to capture one or more still images. In some embodiments the digital camera is a video camera configured to capture a video stream. Accordingly receiving one or more images captured by said image capturing device may include receiving one or more still images and/or receiving a video stream.

The processor is adapted to detect the toy construction elements anchor toy construction models in the captured image(s) and to recognise the toy construction models and/or elements. To this end, the toy system may comprise a library of known toy construction models and or elements, each associated with information about the corresponding virtual object and whether the virtual object has already been unlocked and/or how the toy construction element may be combined with other toy construction models or elements so as to form a composite toy construction model. The information about the corresponding virtual object may e.g. include one or more of the following: a virtual object identifier, information about a visual appearance of the virtual object, one or more virtual characteristics of the virtual object, a progression level in the digital play experience, and/or the like.

While the toy construction elements themselves do not need to be provided with recognisable codes or markers, in some embodiments, this may be useful, anyway. Accordingly, in some embodiments, one or more of the plurality of toy construction elements may include a visually recognizable object code identifying a toy construction element or a toy construction model. In particular, in some embodiments, the plurality of toy construction elements of the system may include one or more marker toy construction elements which may be toy construction elements having a visual appearance representative of an object code or of a part thereof. For example, the toy construction system may comprise two or more marker construction elements that, when interconnected with each other, together have a visual appearance representative of an object code. Accordingly the object code may identify an individual toy construction element or a toy construction model including one or more marker construction elements that together represent the object code. The object code may be represented in the form of a barcode, a QR code or an otherwise machine readable code. Alternatively, the object code may otherwise be encoded in the visual appearance of the marker toy construction element, e.g. invisibly embedded into a graphical decoration, an insignia, a color combination and/or the like. The object code may be different from the unlock code. In some embodiments, the object code is a unique object code, uniquely identifying a particular toy construction element or model, e.g. a serial number or other type of unique code. In other embodiments, the object code is a non-unique object code, i.e. such that there exists two toy construction elements or models that carry the same object code. Use of non-unique object codes may allow the visual markers features representing the object code to be smaller and/or less complex, as the information content required to be represented by the markers/features may be kept small. This allows the codes to be applied to small objects and/or to be applied in a manner that does not interfere too much with the desired aesthetic appearance of the object. For example, the object code to be assigned to a particular toy construction element or model may be selected randomly, sequentially or otherwise from a pool of codes. The pool of codes may or may not be sufficiently larger than the number of toy construction elements or models that are assigned an object code, sufficiently larger for the code to be considered unique. For example, the pool of codes may be comparable in size or even smaller than the number of toy construction elements or models that are assigned an object code, but preferably large enough so that the risk of acquiring two toy construction elements or models having the same object code is acceptably small.

The processor may be configured to detect the object code within the one or more images. The process may then adapt the digital play experience responsive to the detected object code. To this end, the object code may be used in a variety of ways.

In some embodiments, the processor may be configured, responsive to receiving the unlock code, to unlock a virtual object where the digital image is configured to provide a plurality of instances of the virtual object. In particular, the plurality of instances of a virtual object may share one or more common characteristics, such as a common visual appearance and for one or more common virtual attributes indicative of a common virtual behaviour of the virtual object. In particular, the plurality of instances may be recognizable by the user as being instances of the same virtual object. Nevertheless, the plurality of instances may differ from one another by one or more specific characteristics, e.g, variations of the visual appearance, such as different clothing, accessories, etc. and/or by one or more specific virtual attributes, such as a virtual health level, power level and/or the like. For example, a virtual object may evolve during the course of the digital play experience, e.g, responsive to game events, user interaction etc. Examples of such evolution may include changes in one or more virtual object attributes such as virtual health values, virtual capabilities and/or the like. Providing a plurality of instances of the virtual object may include providing instances each having respective attribute values of one or more virtual object attributes. Alternatively or additionally, the digital game may allow a user to customize a virtual object, e.g. by selecting accessories, clothing, etc. Accordingly, the digital game may maintain a plurality of differently customized instance of a virtual object.

The first unlocked virtual object may be associated with a particular recognizable type of toy construction element or toy construction model. Each instance of at least a first virtual object may further be associated with a particular object code in combination with the particular recognizable type of toy construction element or toy construction model.

Hence, in some embodiments, recognizing the first toy construction element or the first toy construction model associated with the first unlocked virtual object may comprise:
recognizing the first toy construction element as a toy construction element of a first type of toy construction elements or recognizing the first toy construction model as a toy construction model of a first type of toy construction models, and
detecting a first object code associated with the recognized first toy construction element or the recognized first toy construction model.

The processor may then be configured, responsive to recognizing the first toy construction element or the first toy construction model, to provide a digital play experience involving a first instance of said first unlocked virtual object, the first virtual object being associated with the first type of toy construction elements or the first type of toy construction models, and the first instance of said virtual object being further associated with the first object code.

In some embodiments, the processor is configured, responsive to recognising the first toy construction element or the first toy construction model associated with a first one of the unlocked virtual objects, to store the detected first object code associated with the first unlocked virtual object. In particular, in some embodiments, the processor may be configured to determine whether an object code has previously been stored associated with the first unlocked virtual object and to associate the detected first object code with the first unlocked virtual object only if no object code has previously been associated with the first unlocked virtual object, e.g, only the first time the first toy construction element or the first toy construction model associated with the first unlocked virtual object has been recognized after the first virtual object has been unlocked.

The processor may further be configured to compare the detected first object code with a previously stored object code associated with the first unlocked virtual object, and to provide the digital play experience involving said first unlocked virtual object only if the detected first object code corresponds, in particular is equal, to the previously stored object code associated with the first unlocked virtual object.

Here and in the following, the term processor is intended to comprise any circuit and/or device suitably adapted to perform the functions described herein. In particular, the term processor comprises a general or special purpose programmable data processing unit, e.g a microprocessor, such as a central processing unit (CPU) of a computer or of another data processing system, a digital signal processor (DSP), an application specific integrated circuits (ASIC), a programmable logic arrays (PLA), a field programmable gate array (FPGA), a special purpose electronic circuit, etc., or a combination thereof. The processor may be integrated into a portable processing device, e.g. where the portable processing device further comprises the image capturing device and a display. It will be appreciated, however, that the toy system may also be implemented as a client server or a similar distributed system, where the image capturing and other user interaction is performed by a client device, while the image processing and recognition tasks and/or the unlock code verification tasks may be performed by a remote host system in communication with the client device. According to some embodiments, an image capturing device or a mobile device with an image capturing device may communicate with a computer, e.g. by wireless communication with a computing device comprising a processor, data storage and a display.

In some embodiments, the image capturing device communicates with a display that shows in real-time a scene as seen by the image capturing device so as to facilitate targeting the desired toy construction model(s) whose image is to be captured.

The present disclosure relates to different aspects including the toy system described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, disclosed herein is a method, implemented by a processor, of operating a toy system, the toy system comprising a plurality of toy construction elements, an image capturing device and the processor; the image capturing device being operable to capture one or more images of one or more toy construction models constructed from the toy construction elements and placed within a field of view of the image capturing device: wherein the method comprises:
executing a digital game, the digital game comprising computer executable code configured to cause the processor to provide a digital play experience;
receiving an unlock code indicative of one or more virtual objects
responsive to receiving the unlock code, unlocking the one or more virtual objects associated with said received unlock code for use in the digital play experience, each virtual object being associated with a respective one of said toy construction elements or with a respective toy construction model constructed from the toy construction elements;
receiving one or more images captured by said image capturing device;
recognising one or more toy construction and/or toy construction models within the one or more images;
responsive to recognising a first toy construction element or a first toy construction model associated with a first one of the unlocked virtual objects, providing a digital play experience involving said first unlocked virtual object.

According to yet another aspect, disclosed herein is a processing device, e.g, a portable processing device, configured to perform one or more of the methods disclosed herein. The processing device may comprise a suitably programmed computer such as a portable computer, a tablet computer, a smartphone, a PDA or another programmable computing device, e.g. a device having a graphical user interface and, optionally, a camera or other image capturing device.

Generally, the digital game may be implemented as a computer program, e.g. as a computer readable medium stored. Accordingly, according to yet another aspect, disclosed herein is a computer program which may be encoded on a computer readable medium, such as a disk drive or other memory device. The computer program comprises program code adapted to cause, when executed by a processing device, the processing device to perform one or more of the methods described herein. The computer program may be embodied as a computer readable medium, such as a CD-ROM, DVD, optical disc, memory card, flash memory, magnetic storage device, floppy disk, hard disk, etc. In other embodiments, a computer program product may be provided as a downloadable software package, e.g. on a web server for download over the interact or other computer or communication network, or as an application for download to a mobile device from an App store. According to one aspect, a computer readable medium has stored thereon instructions which, when executed by one or more processing units, cause the processing unit to perform an embodiment of the process described herein.

The present disclosure further relates to a toy construction set comprising a plurality of toy construction elements, one or more unlock codes, and instructions to obtain a computer program code that causes a processing device to carry out the steps of an embodiment of one or more of the methods described herein, when the computer program code is executed by the processing device. For example, the instructions may be provided in the form of an internet address, a reference to an App store, or the like. The instructions may be provided in machine readable fonn, e.g. as a QR code or the like. The toy construction set may even comprise a computer readable medium having stored thereon the computer program code. Such a toy construction set may further comprise a camera or other image capturing device connectable to a data processing system.

Additional features and advantages will be made apparent from the following detailed description of embodiments that proceeds with reference to the accompanying drawings.

### BRIEF DESCRIPTION OF THE DRAWINGS

Preferred embodiments of the disclosure will be described in more detail in connection with the appended drawings.

FIG. 1 shows the steps of creating a physical model according to one embodiment,

FIG. 2 shows the steps of creating a virtual model from the physical model created by the steps of FIG. 1.

FIGS. 3-7 show the steps of creating a virtual game environment from a physical model according to a further embodiment,

FIGS. 8-17 show the steps of installing and playing a cyclic interactive game according to a yet further embodiment.

FIG. 18 is a physical playable character model with different physical tool models.

FIG. 19 is an interactive game system inch ding a physical playable character model.

FIG. 20 is an example of a triangle indexing scheme in a mesh.

FIG. 21 is an example of a process for creating a virtual environment.

FIG. 22A is an example of a mesh representation of a virtual object.

FIG. 22B is an example of a voxel representation of the virtual object of FIG. 22A.

FIG. 23 is an example of a process for converting a mesh into a voxel representation.

FIG. 24 is an illustration of an example of a triangle and a determined intersection point X of the triangle with the voxel space.

FIG. 25 is a flow diagram of an example of a process for determining the intersection of a mesh with a voxel space.

FIG. 26 is an illustration of an example of a voxelization process.

FIG. 27 is an illustration of a color space.

FIG. 28 is another example of a process for creating a virtual environment.

FIGS. 29A-B show the steps of creating a virtual game environment from a physical model according to a further embodiment.

FIG. 30 shows the steps of creating it virtual game environment from a physical model according to a further embodiment.

FIG. 31 shows another example of a process for creating a virtual environment.

FIGS. 32-34 schematically illustrate examples of toy construction sets of a toy system described herein.

FIGS. 33-37 schematically illustrate examples of use of an embodiment of toy system described herein.

FIG. 38 shows a flow diagram of an example of a process as described herein.

FIG. 39A-C show examples of toy construction models for use with a toy system as described herein.

FIG. 40 schematically illustrates another example of a use of an embodiment of a toy system described herein.

FIGS. 41-42 schematically illustrate examples of a toy system described herein.

### DETAILED DESCRIPTION

Embodiments of the method and system disclosed herein may be used in connection with a variety of toy objects and, in particular with construction toys that use modular toy construction elements based on dimensional constants, constraints and matches, with various assembly systems like magnets, studs, notches, sleeves, with or without interlocking connection etc. Examples of these systems include but are not limited to the toy constructions system available under the tradename LEGO. For example, U.S. Pat. No. 3,005,282 and USD253711S disclose one such interlocking toy construction system and toy figures, respectively.

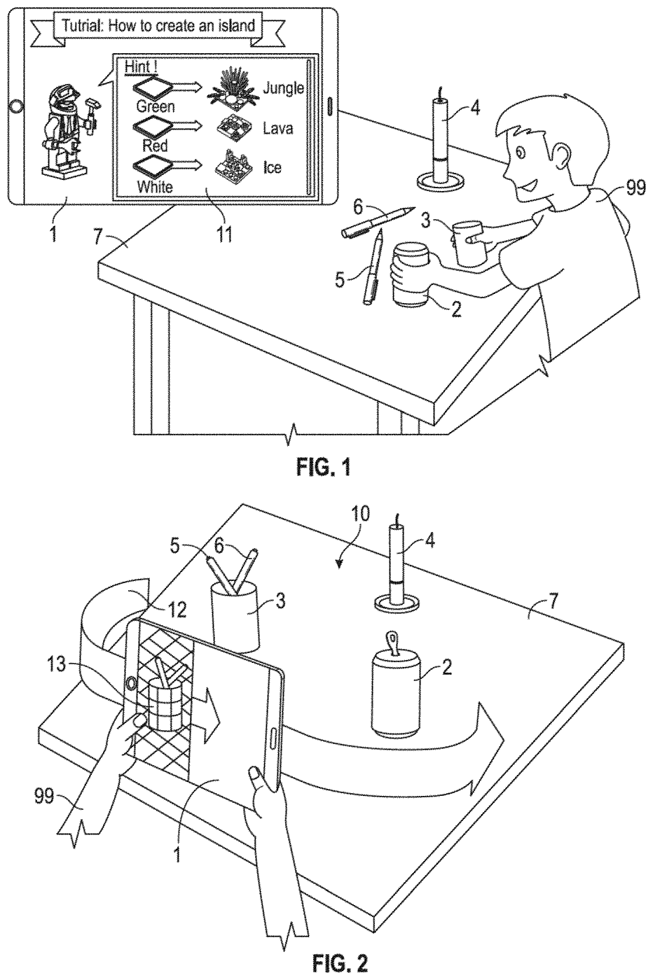

FIG. 1 shows steps of creating a physical model according to one embodiment. The virtual part of the game is played on a mobile device 1, such as a tablet computer, a portable computer, or the like. The mobile device 1 has a capturing device, data storage, a processor, and a display. It will be appreciated, however, that the various embodiments of the process described herein may also be implemented on other types of processing devices. The processing device may comprise a capturing device, data storage, a processor, and a display integrated into a single physical entity; alternatively, one or more of the above components may be provided as one or more separate physical entities that may be communicatively connectable with each other otherwise to allow data transfer between them. Game software installed on the mobile device 1 adapts the mobile device 1 for performing the method according to one embodiment of the disclosure within the framework of an interactive game. The mobile device 1 presents a building tutorial to the user 99. Following the instructions of the tutorial, the user 99 finds a number of physical objects 2, 3, 4, 5, 6 and arranges these physical objects 2, 3, 4, 5, 6 on a physical play zone 7, such as a table top or a floor space, to form a physical model 10 of a game environment. Advantageously, the building tutorial includes hints 11 on how certain predetermined physical properties of physical objects in the physical model of the game environment will be translated by the game system into characteristics of the virtual game environment to be created. This allows the user 99 to select the physical objects 2, 3, 4, 5, 6 according to these predetermined physical properties to wilfully/intentionally build the physical model in order to create certain predetermined characteristics/a certain game behaviour of the virtual game environment according to a predetermined set of rules. By way of example, FIG. 1 shows a hint in the form of a translation table indicating how different values of a predetermined physical property, here colour, are handled by the system, in particular, the user 99 is presented with the hint that green colours on physical objects will be used to define jungle elements, red colours will be used to define lava elements, and white colours will be used to define ice elements in the virtual game environment.

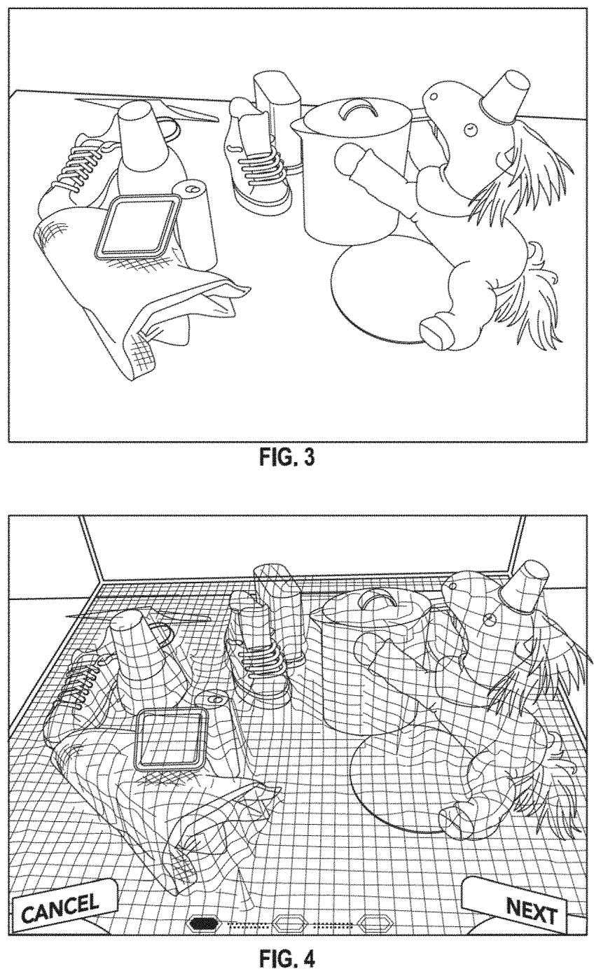

FIG. 2 illustrates steps of creating a virtual model from the physical model 10 created by arranging physical objects 2, 3, 4, 5, 6 on a physical play zone 7. The mobile device 1 is moved along a scanning trajectory 12 while capturing image/scan data 13 of the physical model 10. The image data is processed by the processor of the mobile device 1 thereby generating a digital three-dimensional representation indicative of the physical model 10 as well as information on predetermined physical properties, such as colour, shape and/or linear dimensions. The digital three-dimensional representation may be represented and stored in a suitable form in the mobile device, e.g. in a mesh form. The mesh data is then converted into a virtual toy construction model using a suitable algorithm, such as a mesh-to-LXFML code conversion algorithm as further detailed below. The algorithm analyses the mesh and calculates an approximated representation of the mesh as a virtual toy construction model made of virtual toy construction elements that are direct representations of corresponding physical toy construction elements.

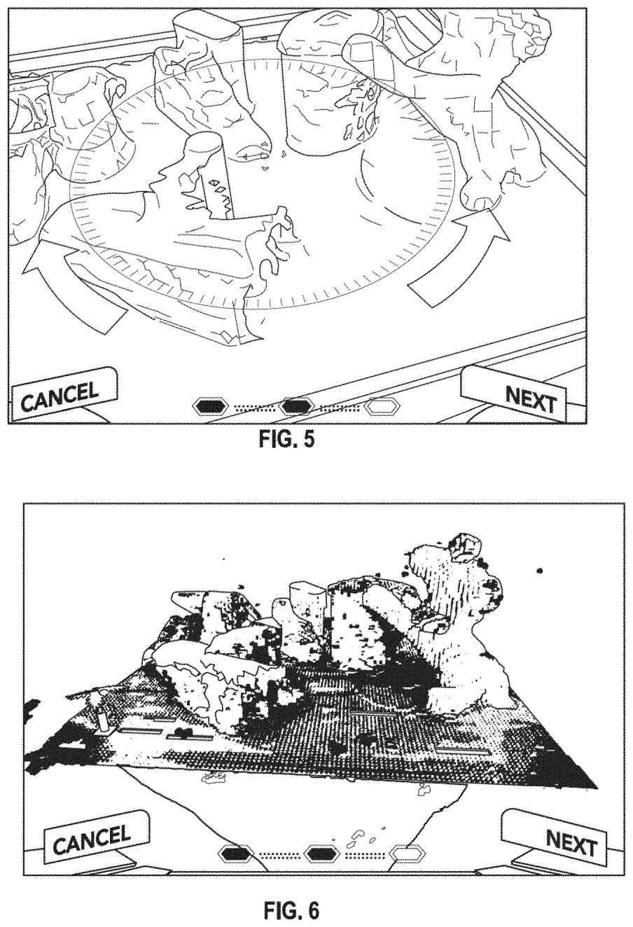

Referring to FIGS. 3-7, steps of creating a virtual game environment from a physical model according to a further embodiment are illustrated by means of screen shots from a mobile device used for performing the steps. FIG. 3 shows an image of a setup of different everyday items found in a home and in a children's room as seen by a camera of the mobile device. These items are the physical objects used for building the physical model of the virtual game environment to be created by arranging the items on a table. The physical objects have different shapes, sizes and colours. The items include blue and yellow sneakers, a green lid for a plastic box, a green can, a folded green cloth, a yellow box, a red pitcher, a grey toy animal with a white tail, mane and forelock as well as a red cup placed as a fez hat, and further items. In FIG. 4 the physical model is targeted using an augmented reality grid overlaid to the view captured by the camera of the mobile device. The camera is a depth sensitive camera and allows for a scaled augmented reality grid to be shown. The augmented reality grid indicates the targeted area captured, which in the present case is a square of 1m by 1m. FIG. 5 shows a screen shot of the scanning process, where the mobile device with the camera pointed at the physical model is moved around, preferably capturing image data from all sides as indicated by the arrows and the angular scale. However, a partial scan. may be sufficient depending on the nature of the three-dimensional image data required for a given virtual game environment to be created. FIG. 6 shows a screen shot after a brickification engine has converted the three-dimensional scan data into a virtual toy construction model made to scale from virtual toy construction elements. The virtual toy construction model also retains information about different colours in the physical model. In FIG. 7 the virtual toy construction model has been enhanced by defining game controlling elements into the scene, thereby creating a virtual game environment where essentially everything appears to be made of virtual toy construction elements. FIG. 7 shows a screen shot of a playable figure exploring the virtual game environment. The playable figure is indicated in the foreground as a colourless/white, three-dimensional virtual mini-figure. Buttons on the right hand edge of the screen are user interface elements for the game play.

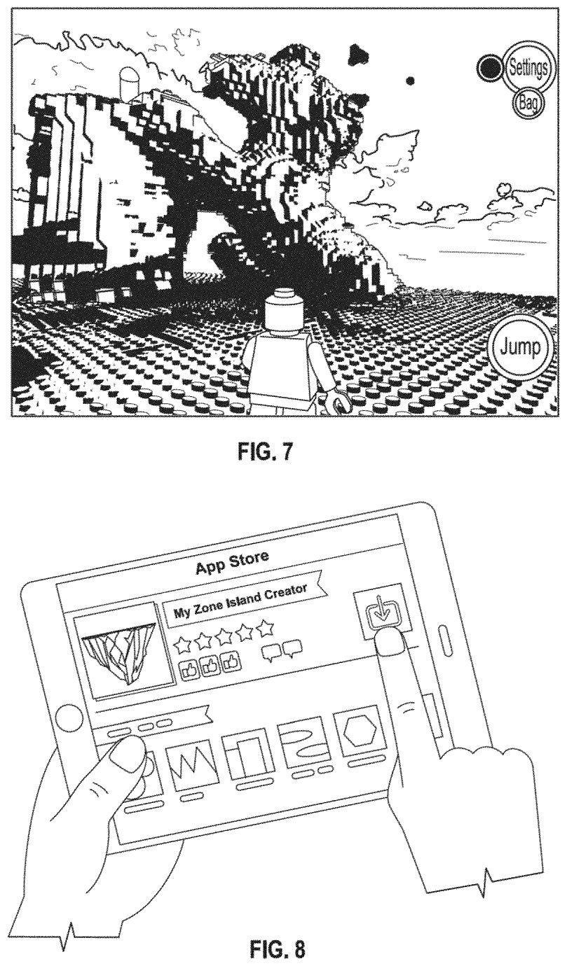

Now referring to FIGS. 8-17, steps of installing and playing a cyclic interactive game according to a yet further embodiment are illustrated schematically. In FIG. 8, the software required for configuring and operating a mobile device for its use in an interactive game system according to the present disclosure is downloaded and installed. Upon startup of the game software, a welcome page may be presented to the user as seen in FIG. 9, from which the user enters a building mode. The user may now be presented with a building tutorial and proceed to building a physical model and creating a virtual game environment as indicated in FIGS. 10 and 11, and as already described above with reference to FIGS. 1 and 2. The physical objects used for constructing the physical model are grey pencils, a brown book, a white candle standing upright in a brown foot, a white cup (in the right hand of the user in FIG. 10) and a red soda can (in the left hand of the user on FIG. 10). Once the virtual game environment is created, the user may proceed to game play by exploring the virtual game environment created as seen in FIG. 12. Before embarking on a virtual mission in the virtual game environment, the user may make a number of choices as, such as selecting a playable character and/or tools from a number of unlocked choices (top row in FIG. 13). A number of locked choices may also be shown (bottom row in FIG. 13). FIGS. 14 and 15 show different screenshots of a playable character on different missions (grey figure with blue helmet). The playable character is equipped with a tool for harvesting resources (carrots). In FIG. 14, the playable character is merely on a collecting mission. Seen in the background of the screenshot of FIG. 14 is a lava mountain created from the red soda can in the physical model. The same virtual game environment created from the same physical model is also shown in FIG. 15, but from a different angle and at a different point in the course of the game. The lava mountain created from the red soda can is shown in the landscape on the right hand side. The white cup of the physical model has been turned into an iceberg surrounded in its vicinity by ice and snow. The game environment has now spawned monsters /adversaries that compete with the playable figure for the resources to be collected (e.g. carrots and minerals). and which may have to be defeated as a part of a mission. In FIG. 16, the user has successfully completed a mission and is rewarded, e.g, by an amount of in-game currency. The in-game currency can then be used to unlock new game features, such as tools/powers/new playable characters/game levels/modes or the like. After reward and unlocking of game features, the user may receive a new mission involving a rearrangement of the physical model, thereby initiating a new cycle of the interactive game. The cycle of a cyclic interactive game is shown schematically in FIG. 17. The game system provides a task (top) and the user creates a virtual game environment scene from physical objects (bottom right); the user plays one or more game segments in the virtual game environment/scene (bottom left); and in response to the outcome of the game play, a new cycle is initiated by the game system (back to the top).

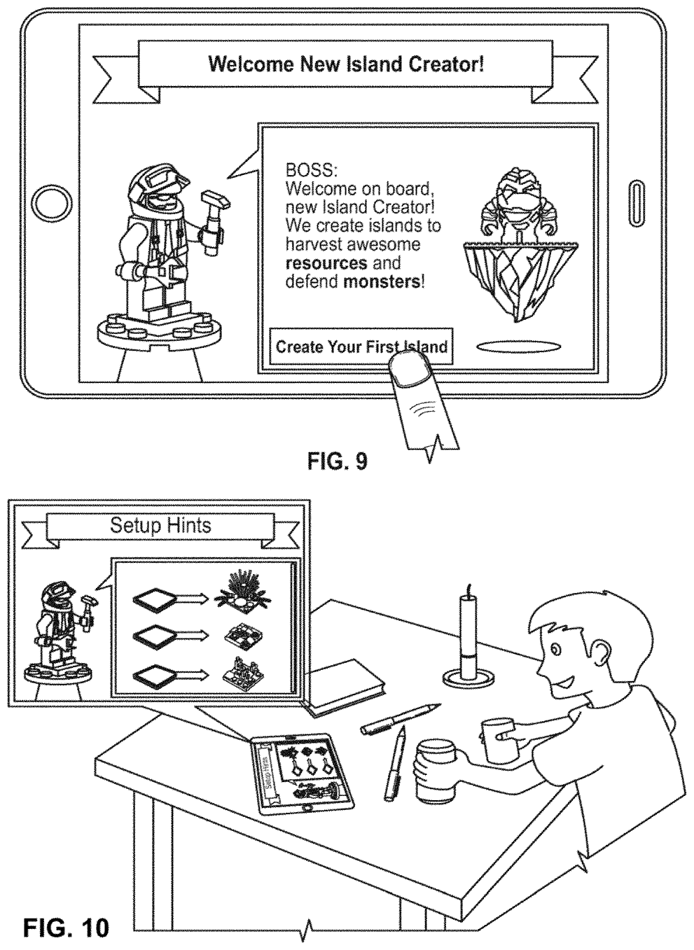

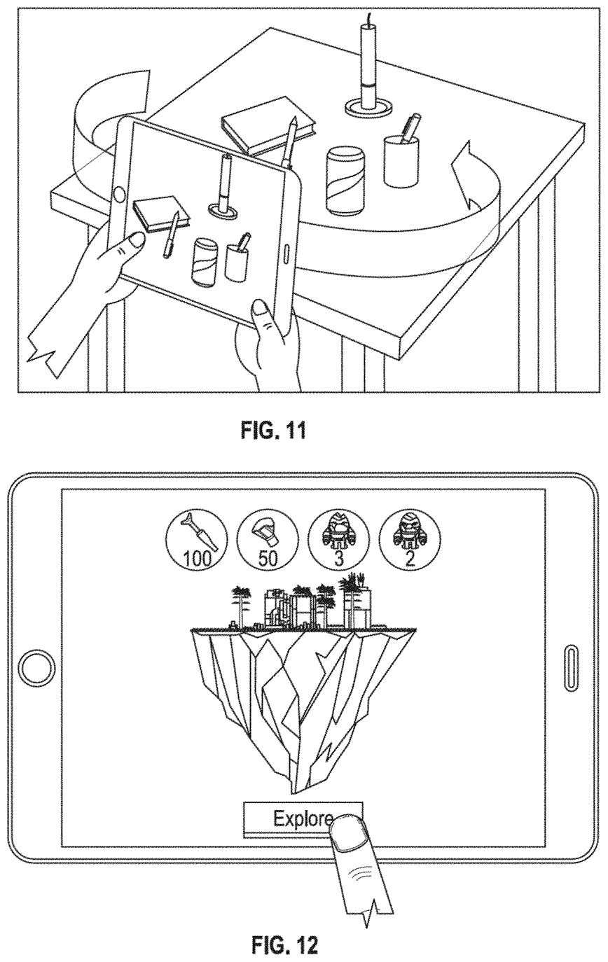

FIG. 18 shows an example of a physical playable character model with different physical tool models. The physical playable character model is for use in an interactive game system. The playable character model may be fitted with a choice of the physical tool models. By way of example, a selection of physical tool models is shown in the bottom half of FIG. 18. Each physical tool model represents specific tools, powers and/or skills. FIG. 19 shows an interactive game system including the physical playable character model of FIG. 18. The physical playable character model may be used for playing, e.g. role playing, in the physical model created by means of the physical objects as shown in the background. By entering information about the physical playable character model and the tools with which it is equipped in the game, a corresponding virtual playable character model is created for game play in the virtual game environment as indicated on the display of the handheld mobile device in the foreground of FIG. 19 (bottom right). Note also, that on the schematic view a physical play zone has been defined by a piece of green card board on the table top. The green card board has been decorated with colour pencils to mark areas on the physical play zone that in the virtual game environment are converted into rivers with waterfalls over the edge of the virtual scene as shown schematically on the handheld mobile device in the foreground.

An important step in creating the virtual game environment is the conversion of the digital three-dimensional representation obtained from, or at least created on the basis of data received from, the capturing device into a virtual toy construction model constructed from virtual toy construction elements or into another voxel based representation. In the following an example will be described of a conversion engine adapted for performing such a conversion, in particular a conversion engine for conversion from a mesh representation into an LXFML. representation. It will be appreciated that other examples of a conversion engine may perform a conversion into another type of representation.

With the evolution of computers and computer vision it is becoming easier for computers to analyze and represent three-dimensional objects in a virtual world. Different technologies exist nowadays that facilitate the interpretation of the environment, creating three-dimensional meshes out of normal pictures obtained from normal cameras or out of depth camera information.

This means that computers, smartphones, tablets and other devices will increasingly be able to represent real objects inside an animated world as three-dimensional meshes. In order to provide an immersive game experience or other types of virtual game experiences, it would be of great value if whatever a computer could “see” and represent as a mesh could then be transformed into a model built out of toy construction elements such as those available under the name LEGO or at least as a voxel-based representation.

Virtual toy construction models may be represented in a digital representation identifying which virtual toy construction elements are comprised in the model, their respective positions and orientations and, optionally, how they are interconnected with each other. For example, the so-called LXFML format is a digital representation suitable for describing models constructed from virtual counterparts of construction elements available under the name. It is thus desirable to provide an efficient process for converting a digital mesh representation into a LEGO model in LXFML format or into a virtual construction model represented in another suitable digital representation.

Usually, three-dimensional models are represented as meshes. These meshes are typically collections of colored triangles defined by the corners of the triangles (also referred to as vertices) and an order of how these corners should be grouped to form these triangles (triangle indexes). There is other information that a mesh could store but the only other thing relevant for this algorithm is the mesh color.

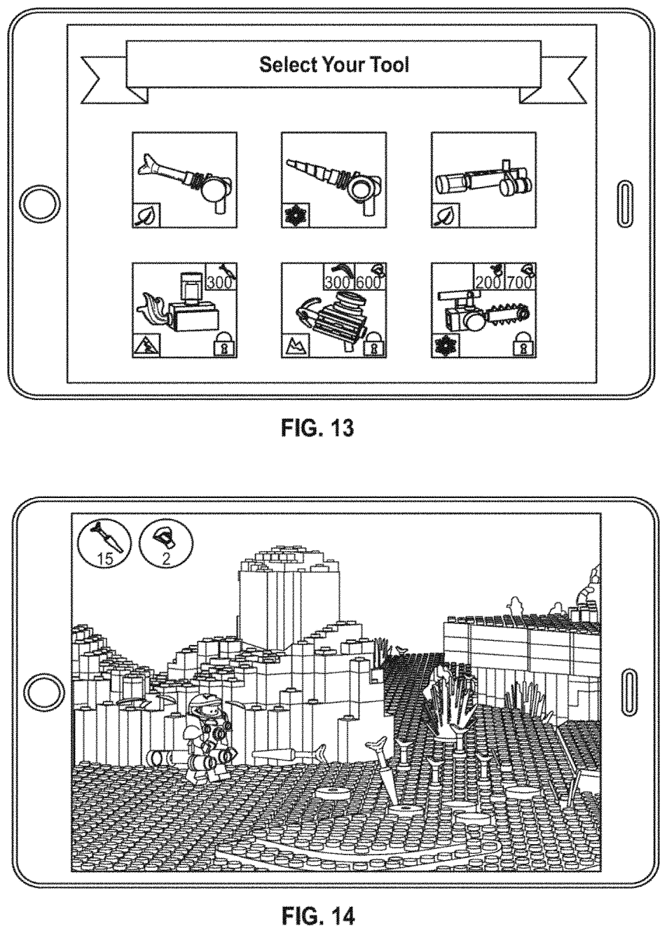

As described earlier, the algorithm receives, as an input, mesh information representing, one or more objects. The mesh information comprises:
Mesh vertices/vertex positions: the coordinates of the points that form the triangles, meaning points in space, e.g. represented as vectors (x,y,z), where x,y,z can he any real number.
Triangle indexes: the indexes of the vertices in consecutive order so that they form triangles, i.e. the order in which to choose the vertices from the positions in order to draw the triangles in the mesh. For example, FIG. 20 illustrates an example of an indexing scheme for a simple surface defined by 4 points labelled 0, 1, 2 and 3, respectively, defining a rectangle. In this example, an array of indexes like {0,1,2,3,0} may be defined to represent how triangles may be defined to represent the surface. This means that a process starts from point 0, proceed to point 1, then to point 2. That is the first triangle. The process may then proceed from the current point (point 2) to define the next triangle, so the process only needs the remaining 2 points, which are 3 and 0. This is done in order to use less data to represent the triangles.
Mesh color .information: the colors that the triangles have.

Embodiments of the process create a representation of a virtual construction model, e.g. an LXFML string format version 5 or above. The LXFML representation needs to include the minimum information that would be needed by other software tools in order to load the information inside. The following example will be used to explain an example of the information included n an LXFML file:

| | |
|---|---|
| 1 | <?xml version=“1.0” encoding=“UTF-8” standalone=“no” ?> |
| 2 | <LXFML versionMajor=“5” versionMinor=“0” name=“Untitled”> |
| 3 | <Meta> |
| 4 | <Application name=“VoxelBrickExporter” versionMajor=“0” |

versionMinor=“1”/>

| | |
|---|---|
| 5 | </Meta> |
| 6 | <Bricks> |
| 7 | <Brick refID=“0” designID=“3622”> |
| 8 | <Part refID=“0” designID=“3622” materials=“316”> |
| 9 | <Bone refID=“0” |

transformation=“5.960464E−08,0,0.9999999,0,1,0,−0.9999999,0,5.960464E−
08,0,1.6,20”>

| | |
|---|---|
| 10 | </Bone> |
| 11 | </Part> |
| 12 | </Brick> |
| 13 | </Bricks> |
| 14 | </LXFML> |

The first line merely states the format of the file.

The second line contains information about the LXFML version and the model na The LXFML version should preferably be 5 or higher. The model name serves as information only. it does not of the loading/saving process in any way.

A <Meta>section is where optional information is stored. Different applications can store different information in this section if they need to. The information stored here does not affect the loading process.

Line 4 provides optional information about what application exported the LXFML file. This may be useful for debugging purposes.

The subsequent lines include the information. about the actual toy construction elements (also referred to as bricks). The refID should be different for every brick of the model (a number that is incremented. every time a brick is exported will do just fine). The design ID gives information about the geometry of the brick and the materials give information about the color. The transformation is the position and rotation of the brick represented by a 4 by 4 matrix but missing the 3^{rd} column.

This information is considered sufficient. One could test the validity of an LXFML file by loading it with the free tool. LEGO Digital. Designer that can be found at http://ldd.lego.com.

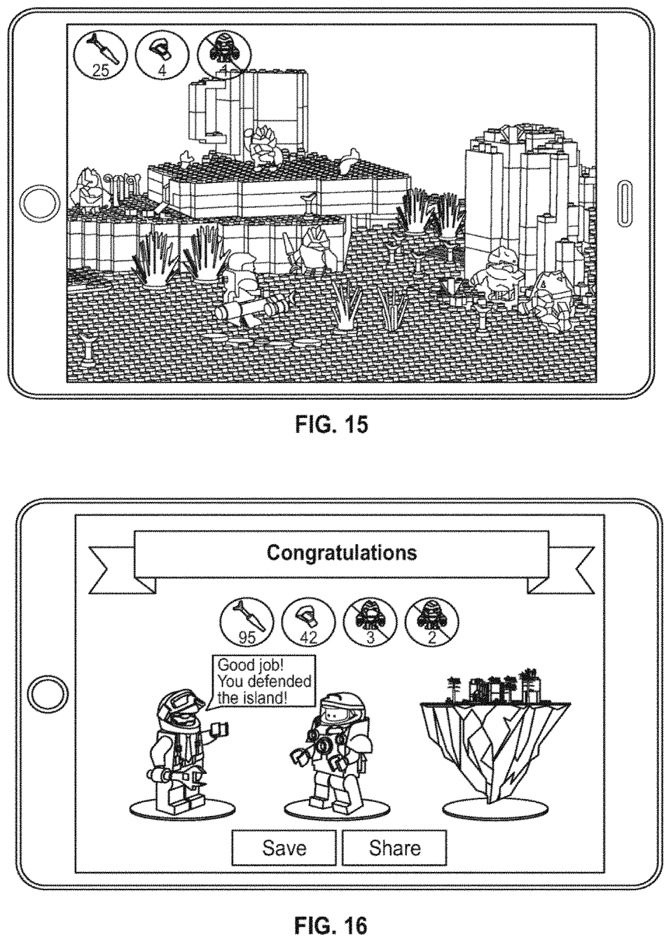

FIG. 21 shows a flow diagram illustrating the steps of an example of a process for converting a mesh into a representation of a virtual toy construction model. These steps are made independent because sometimes not all of them are used, depending on the situation.

In initial step S1, the process receives a mesh representation of one or more objects. For the purpose of the present description, it will be assumed that the process receives a mesh including the following information:
Vm=mesh vertices.
Tm=mesh triangles.
Cm=mesh color; (Per vertex color)

It will be appreciated that, instead of a mesh color, the mesh may represent another suitable attribute, such as a material or the like. Nevertheless, for simplicity of the following description, reference will be made to colors.

In an initial conversion step S2, the process converts the mesh into voxel space. The task addressed by this sub-process may be regarded as the assignment of colors (in this example colors from a limited palette 2101 of available colors, i.e. colors from a finite, discrete set of colors) to the voxels of a voxel space based on. a colored mesh The mesh should fit the voxel space and the shell that is represented by the mesh should intersect different voxels. The intersecting voxels should be assigned the closest color from the palette that corresponds to the local mesh color. As this technology is used in computer implemented applications such as gaming, performance is very important.

The initial sub-process receives as an input a mesh that has color information per vertex associated with it. It will be appreciated that color may be represented in different ways, e.g. as material definitions attached to the mesh. Colors or materials may be defined in a suitable software engine for three-dimensional modelling, e.g. the system available under the name “Unity”.

The mesh-to-voxel conversion process outputs a suitable representation of a voxel space, e.g. as a three-dimensional array of integer numbers, where each element of the array represents a voxel and where the numbers represent the color ID, material ID or other suitable attribute to be assigned to the respective voxels. All the numbers should be 0 (or another suitable default value) if the voxel should not be considered an intersection; otherwise, the number should represent a valid color (or other attribute) ID from the predetermined color/material palette, if a triangle intersects the voxel space at the corresponding voxel. The valid color should preferably be the closest color from the predetermined palette to the one the triangle intersecting the voxel has.

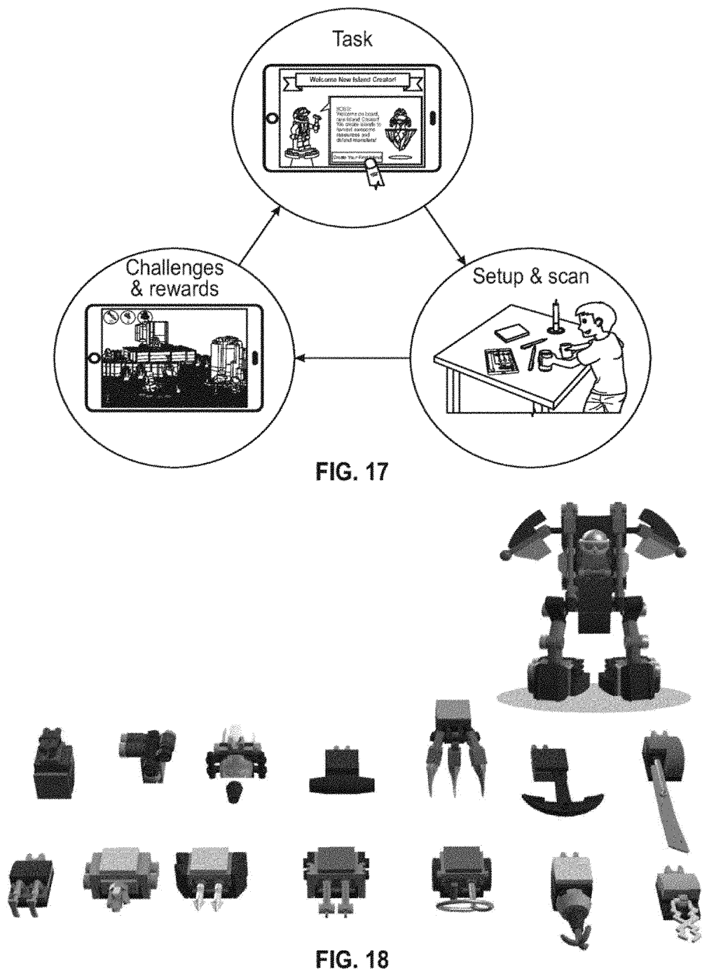

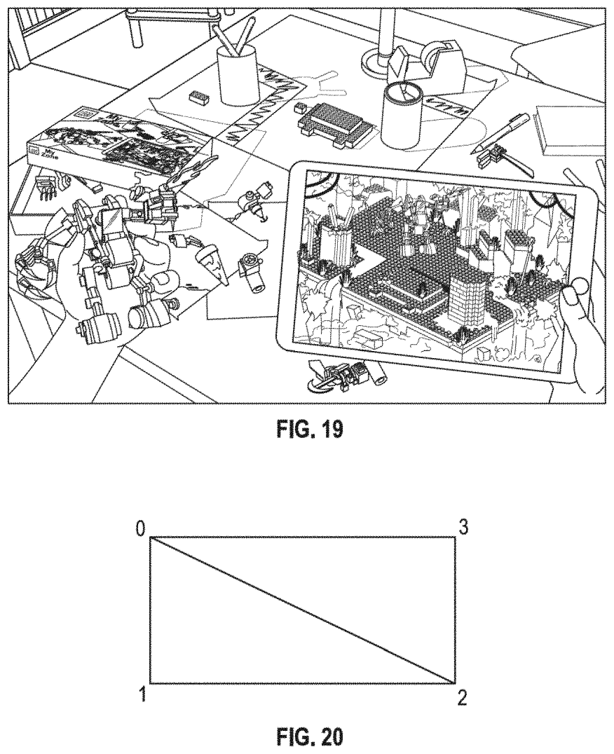

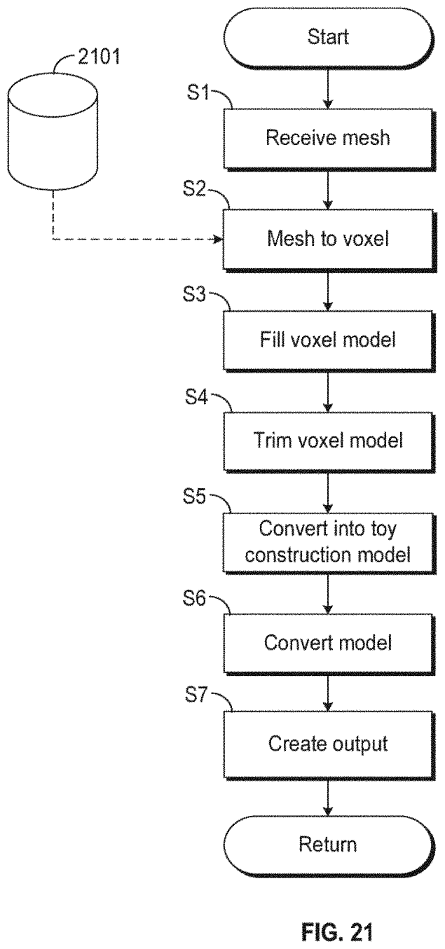

FIG. 22A shows an example of a mesh representation of an object while FIG. 22B shows an example of a voxel representation of the same object where the voxel representation has been obtained by an example of the process described in the following with reference to FIG. 23.

So the task to be performed by the initial sub-process may be regarded as: given a mesh model, determine a voxel representation that encapsulates the mesh model and has as voxel color the closest one of a predetermined set of discrete colors to the mesh intersecting the voxel(s).

Initially converting the mesh into a voxel representation is useful as it subsequently facilitates the calculation of where different toy construction elements should be positioned, Voxels may be considered boxes of size X by Y by Z (although other types of voxels may be used). Voxels may be interpreted as three-dimensional pixels. The conversion into voxels may be useful in many situations, e.g. when the model is to be represented as virtual toy construction elements in the form of box shaped bricks of size X′ by Y′ by Z′. This means that any of the bricks that we might have in the model will take up space equal to a multiple of X, Y, Z by the world axis x, y and z.

In order to create the voxel space needed for the model that is to be converted, the process starts at step S2301 by creating an axis-aligned bounding box around the model. The bounds can be computed from the mesh information. This can be done in many ways; for example the Unity system provides a way to calculate bounds for meshes. Alternatively, a bound can he created out of two points: one containing the minimum coordinates by x, y and z of all the vertices in all the meshes and the other containing the maximum values by x, y and z, like in the following example:

Pminₓ=Minₓ(Vm1ₓ, Vm2ₓ . . . ) Pmaxₓ=Maxₓ(Vm1, Vm2ₓ. . . )

Pmin_{y}=Min_{y}(Vm1_{y}, Vm2_{y} . . . ) Pmax_{y}=Max_{y}(Vm1_{y}, Vm2_{y} . . . )

Pmin_{z}=Min_{z}(Vm1_{z}, Vm2_{z} . . . ) Pmax_{z}=Max_{z}(Vm1_{z}, Vm2_{z} . . . )

Pmin=(Pminₓ, Pmin_{y}, Pmin_{z}) Pmax=(Pmaxₓ, Pmax_{y}, Pmax_{z})

Pmin and Pmax are the minimum and maximum points with coordinates x, y and z. Max and Min are the functions that get the minimum and maximum values from an array of vectors Vm by a specific axis (x,y or z).

Having the opposite corners of a box should be sufficient to define it. The box will have the size B=(bx, by, bz) by axis x, y and z. This means that B=Pmax−Pmin;

In a subsequent step S2302, the process divides he voxel space into voxels of a suitable size, e.g. a size (dimx, dimy, dimz) matching the smallest virtual toy construction element of a system of virtual toy construction elements. Preferably the remaining virtual toy construction elements have dimensions corresponding to integer multiples of the dimensions of the smallest virtual toy construction element. In one example, a voxel has dimensions (dimx, dimy, dimz)=(0.8, 0.32, 0.8) by (x,y,z) which is the size of a 1×1 Plate LEGO plate (LEGO Design ID: 3024). By creating the Voxel Space corresponding to the bounding box we will create a Matrix of size V(vx,yy,vz), where vx=bx/dimx+1, vy=by/dimy+1 and vz=bz/dmiz+1. The +1 appears because the division will almost never be exact and any remainder would result in the need of having another voxel that will need filling.

The matrix will contain suitable color IDs or other attribute IDs. This means that a voxel will start with a default value of 0 meaning that in that space there is no color. As soon as that voxel needs to be colored, that specific color ID is stored into the array. In order to process the mesh, the process processes one triangle at a time and determines the voxel colors accordingly, e.g. by performing the following steps:
Step S2303: Get next triangle
Step S2304: Get the intersection of the triangle with the voxel space Step S2305: Compute a raw voxel color of the intersecting voxel(s).
S2306: Get the color ID of the closest color from the raw voxel color and so the subsequent bricks can be created with a valid color. Step S2307: Mark the voxels) with the determined color ID.

These steps are repeated until all triangles are processed.

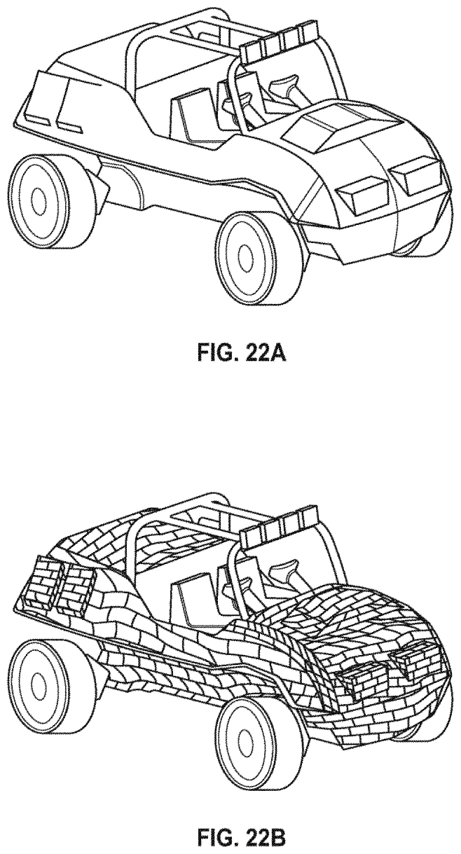

The computation. of the raw voxel color to be assigned to the intersecting voxels (Step S2305) may be performed in different ways. Given the input, the color of a voxel can be calculated based on the intersection with the voxel and the point/area of the triangle that intersects with the voxel or, in case of triangles that are small and the color variation is not that big, it could be assumed that the triangle has the same color and that is the average of the 3 colors in the corners. Moreover, it is computationally very cheap to calculate the average triangle color and approximate just that one color to one of the set of target colors. Accordingly:
In one embodiment, the process may simply average out the color of the triangle using the 3 vertex colors and then use the average color fir all intersections.
an alternative embodiment, the process computes where on the triangle is the intersection with the voxel space. FIG. 24 illustrates an example of a triangle and a determined intersection point X of the triangle with the voxel space. Then the process computes the color as follows (see FIG. 24):
Having the 3 colors Ca. Cb and Cc associated to the vertices/vectors A, B and C, the intersecting color is C=⅙ * Σ_{B}^{A}[(Xab * Cb+(AB−Xab) * Ca)/AB+(Xcb * Cb+(CB−Xcb) * Cc)/CB], where Xab is the distance from the intersection of the triangle with the voxel space along the AB axis, AB is the distance from a to B and the sum represents the same process applied for A, B and C to obtain a color blend.

While the first alternative is faster, the second alternative provides higher quality results.

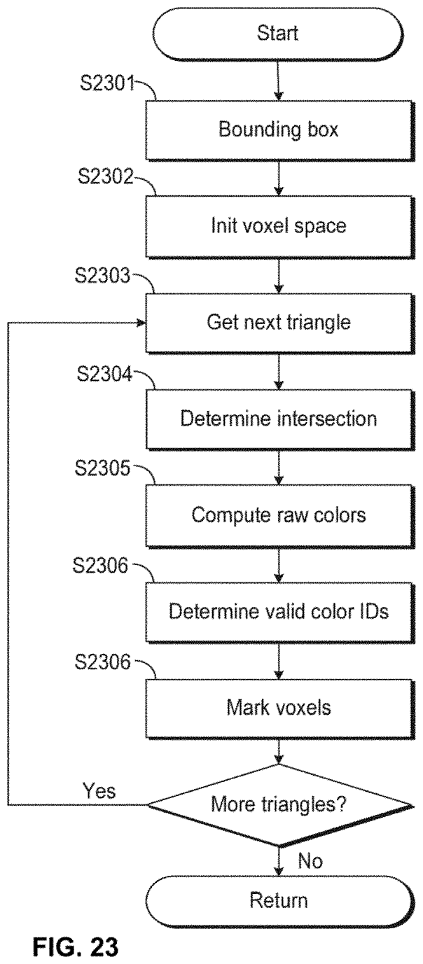

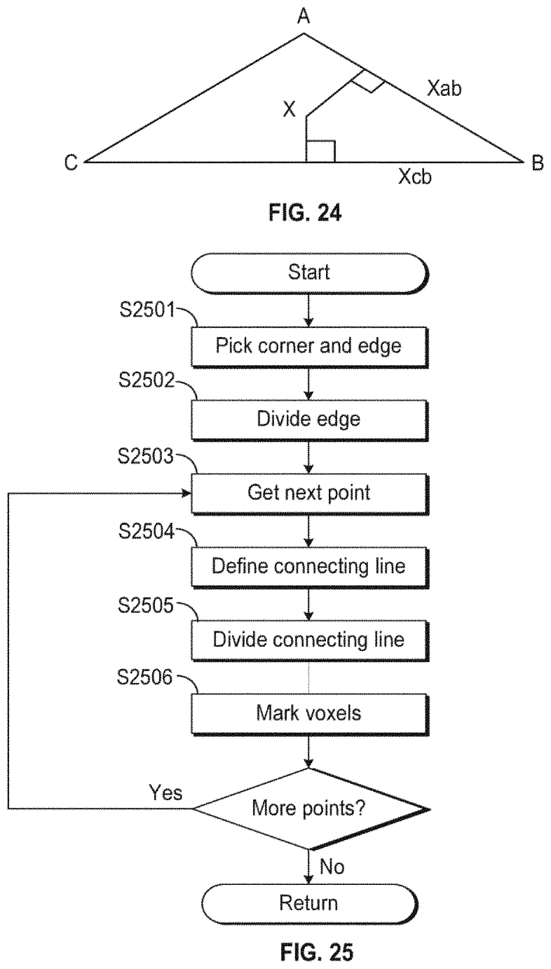

The determination of the intersection of the triangle with the voxel space (step S2304 may be efficiently performed by the process illustrated in FIGS. 25 and 26 and as described as follows. In particular, FIG. 25 illustrates a flow diagram of an example of the process and FIG. 26 illustrates an example of a triangle 2601. Since it is fairly easy to convert a point in space to a coordinate in voxel space, the process to fill the voxels may be based on points on the triangle as illustrated in FIG. 26. The steps of the sub-process, which is performed for each triangle of the mesh, may be summarized as follows:

Step S2501: select one corner (corner A in the example of FIG. 26) and the edge opposite the selected corner (edge BC in the example of FIG. 26).

Step S2502: Define a sequence of points BC1-BC5 that divide the opposite edge (BC) into divisions equal to the smallest dimension of a voxel, e.g. dimy=0.32 in the above example. The points may be defined as end points of a sequence of vectors along edge BC, where each vector has a length equal to the smallest voxel dimension. Since, in three-dimensional, it is highly unlikely to have integer divisions, the last vector will likely end between. B and C rather than coincide with C.

The process then processes all points BC1-BC5 defined in the previous step by performing the following steps:

Step S2503: Get next point

Step S2504: The process defines a line connecting the corner picked at step S2501 with the current point on the opposite edge.

Step S2505: The process divides the connecting line into divisions with the size equal to the smallest dimension of a voxel, again dimy=0.32 in the above example. Hence, every point generated by the split of step S2502, connected with the opposite corner of the triangle (A in the example of FIG. 26) forms a line which is to he split in the same way, but starting from the point on the edge (BC) so that the last point that might not fall into the point set because of the non integer division be A. At last, AC should be split into points.

Step S2506: For every point on the line that was divided at Step S2505 and for point A, the process marks the voxel of the voxel space that contains this point with the raw color computed as described above with reference to step S2305 of FIG. 23. This mapping may be done very efficiently by aligning the model to the voxel space and by dividing the vertex coordinates to the voxel size The process may allow overriding of voxels. Alternatively, the process may compute weights to determine which triangle intersects a voxel most. However, such a computation is computationally more expensive.

This simple pseudocode shows how the voxel representation of the mesh can be created using just the mesh information. The amount of operations done is not minimal as the points towards the selected corner (selected at Step S2501) tend to be very close to each other and not all of them would be needed. Also the fact that the triangle could be turned at a specific angle would mean that the division done at Step S2506 may take more steps than necessary. However, even though there is a lot of redundancy, the operation is remarkably fast on any device and the complexity of calculations needed to determine the minimum set of points would likely result in having a slower algorithm.

Again referring to FIG. 23, the determination of the closest color from a palette of discrete colors (step S2306) may also be performed in different ways:
In one embodiment, which results to a high quality color mapping, the process initially transforms RGB colors into LAB space. With the LAB representation of colors, the process applies the DeltaE color distance algorithm to compute the distance from the actual color (as determined from the mesh) and the other available colors from the palette. A more detailed. description of this method is available at http://en.wikipedia.org/wiki/Color_difference.
In another embodiment, which is faster than the first embodiment, the process calculates the difference between the valid colors of the palette and the given color (as determined from the mesh). The process then selects the color of the palette that corresponds to the shortest distance.

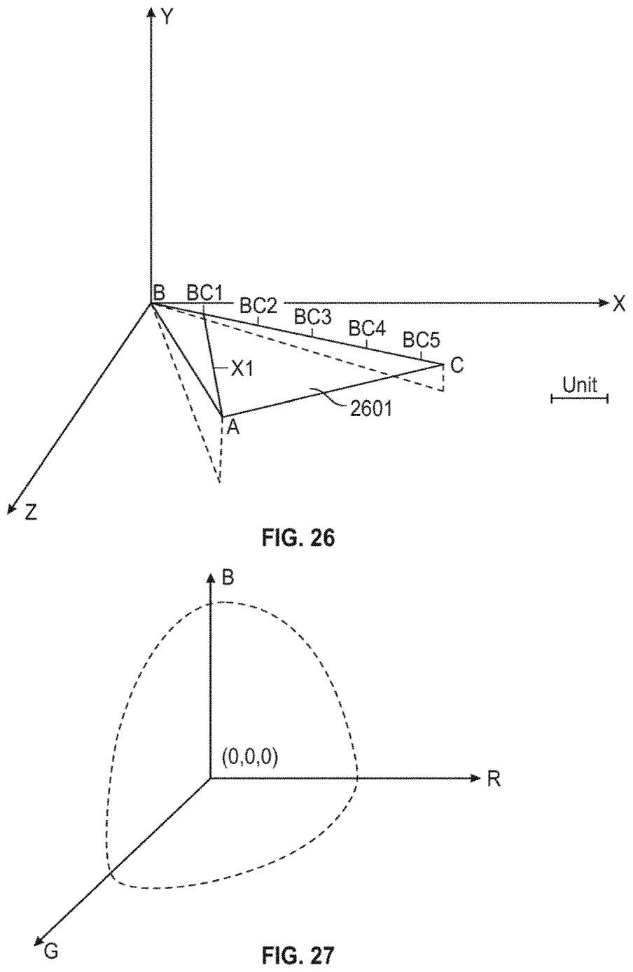

One way to find the shortest distance is to compare all distances in three-dimensional. This means that any color that is to be approximated has to be compared with all possible colors from the palette. A more efficient process for determining the closest distance between a color and the colors of a palette of discrete colors will be described with reference to FIG. 27:

All colors in RGB space may be represented in three-dimensional as an 8^{th} of a sphere/ball sectioned by the X, Y and Z planes with a radius of 255. If a color C with components rC, gC, bC containing the red, green and blue components is given as input for the conversion step, color C will be situated at distance D from the origin.

The minimum distance may then be found by an iterative process starting from an initial value of the minimum distance. The maximum distance from the origin to the closest target color from the palette that should be found must be no larger than the distance from the origin to the original color plus the current minimum distance. The initial minimum is thus selected large enough to cover all possible target colors to ensure that at least one match is found.

An example of how the process works is as fallows: a current minimum distance is found, meaning that there is a target color that is close to the input color. Now, no target color can be found in such way that it is closer to the original color, yet further away from origin than the distance between the original color and the origin plus the current minimum distance. This follows from the fact that the minimum distance determines the radius of the sphere that has the original color in its center and contains all possible, better solutions. Any better solution should thus be found within said sphere; otherwise it would be further away from the original color. Consequently, for a given current minimum distance, only colors need to be analyzed that are at a distance from the origin smaller than the original color distance + the current minimum.

The above conversion process results in a voxel model of the hull/contour of the object or objects. It has been found that the process provides a quality output at an astounding speed because:
if all the units are at maximum distance equal to the minimum size of a voxel, one can't get 2 points that are further away than a voxel so there will never be holes.
if the triangles are small and many, and if the model is big, all the small voxel overrides that might give a voxel that does not have the best color for a few voxel will be tolerable.
The color approximation is good. enough while at the same time saves a lot of computation power.

This solution may be compared in performance to the standard solutions (raycasting and volume intersection) which instead of just using a given set of points in space try to determine if triangles intersect different volumes of space and, in some cases, some methods even try to calculate the points where the triangle edges intersect the voxels. The volume intersection method is expected to be the slowest, but the intersection points are expected to provide accurate areas of intersection which could potentially facilitate a slightly more accurate coloring of the voxels.

Instead of computing different intersections, another method that is commonly used to determine intersections is called raycasting. Rays can be casted in a grid to determine what mesh is hit by specific rays. The raycasting method is not only slower but also loses a bit of quality as only the triangles hit by the rays contribute to the coloring. The raycasting method could give information about depth and could help more if operations need to be done taking in the consideration the interior of the model.

Again referring to FIG. 21, the mesh-to-voxel conversion of step S2 typically results in a hollow hull, as only voxels intersecting the surface mesh have been marked with colors. In some situations it may be desirable to also map colors onto internal voxels while, in other situations, it may be desirable not to fill out the voxel model. For example, sometimes the model should be empty, e.g. when the model represents a hollow object, e.g. a ball. Moreover, it takes more time to calculate what is the inside volume of the model and it also affects the amount of bricks in the model. This makes all the subsequent steps slower because more information is handled. On the other hand, sometimes, especially if creating landscapes, it is desirable that a model is full rather than just an empty shell.

Accordingly, in the subsequent, optional step S3, the process may fill the internal, non-surface voxels with color information. The main challenge faced when trying to fill the model is that it is generally hard to detect if the voxel that should be filled is inside the model or outside. Ray casting in the voxel world may not always provide a desirable result, because if a voxel ray intersects 2 voxels, this does not mean that all voxels between the two intersection points are inside the model. If the 2 voxels contained, for example very thin triangles, the same voxel could represent both an exit and an entrance.

Raycasting on the mesh can be computationally rather expensive and sometime inaccurate, or it could be accurate but even more expensive, and therefore a voxel based solution may be used for better performance.

It is considerably easier to calculate the outside surface of the model because the process may start with the boundaries of the voxel world. If those points are all taken then everything else is inside. For every voxel that is not occupied because of triangle intersections one can start marking every point that is connected to that point as being a point in the exterior. This procedure can continue recursively and. it can fill the entire exterior of the model.

Now that the edge is marked and the exterior is marked, everything in the voxel space that is unmarked (still holds a value of 0) is inside the model.

Now, a voxel raycasting can be done to shoat rays by any axis and fill in any unoccupied voxel. Currently, the color of voxel that intersects the entering ray is used to color the interior. As the mesh holds no information about how should the interior be colored, this coloring could be changed to be application specific.

In subsequent, optional step S4, the created voxel :representation may be post-processed, e.g. trimmed. For example, such a post-processing may be desirable in order to make the voxel representation more suitable for conversion into a virtual toy construction model. For example, toy construction elements of the type known as LEGO often have coupling knobs. When the volume defined by the mesh is not too big, an extra knob could make a huge difference for the overall appearance of the model; therefore, for bodies with volumes less than a certain volume, an extra trimming process may be used. For example, the minimum volume may be selected as 1000 voxels or another suitable limit.

The trimming process removes the voxel on top of another voxel; if there is only one voxel that exists freely it is removed also. This is clone because the LEGO brick also has knobs that connect to other bricks. Since the knob of the last brick on top is sticking out it could mark another voxel but we might not want to put a brick there because it will make the already existing small model even more cluttered. For this reason the extra trimming process may optionally be used for small models. Of course, it could also be used on bigger models but it will introduce extra operations that might not provide observable results.

The trimming process may e.g.. be performed as follows: For every occupied voxel, the process checks if there is an occupied voxel on top; if not, it marks the occupied voxel for deletion. Either lonely voxels or the top most voxels will be removed this way. The voxels on top are collected and removed all at the same time because if they would remove themselves first the voxel underneath might appear as the top-most voxel.

After the voxel space is filled (and, optionally, trimmed), either just the contour or the interior also, some embodiments of the process may create a virtual environment directly based on the voxel representation while other embodiments may create a toy construction model as described herein.

Accordingly, in the subsequent step SS, the process parses the voxel space and creates a data structure, e.g. a list, of bricks (or of other types toy construction elements). It will be appreciated that, if a raw voxel representation of a virtual environment is desired, alternative embodiments of the process may skip this step.

In order to obtain the bricks that can be placed, a brick evolution model is used, i.e. a process that starts with a smallest possible brick (the 3024, 1×1 plate in the above example) and seeks to fit larger bricks starting from the same position. Hence the initial smallest possible brick is caused to evolve into other types of bricks. This can be done recursively based on a hierarchy of brick types (or other types of toy construction elements). Different bricks are chosen to evolve into specific other bricks. To this end the process may represent the possible evolution paths by a tree structure. When placing a brick the process will try to evolve the brick until it cannot evolve anymore because there is no other brick it can evolve into or because there are no voxels with the same color it can evolve over.

An example of this would be: a 1×1 Plate is placed in the origin. It will try to evolve into a 1×1. Brick by looking to see if there are 2 voxels above it that have the same color. Assuming there is only one and therefore it cannot evolve in that direction, the process will then try to evolve the brick into a 1×2 Plate in any of the 2 positions (normal, 90 degree rotated around the UP axis). If the brick is found to be able to evolve into a 1×2 plate then the process will continue until it will run out of space or evolution possibilities. In one embodiment, the supported shapes are 1×1 Plate, 1×2 Plate, 1×3 Plate, 1×1, Brick, 1×2 Brick, 1×3 Brick, 2×2 Plate, 2×2 Brick, but more or other shapes can he introduced in alternative embodiments.

After the brick evolution of a brick has finished, the process clears the voxel space at the location occupied by the evolved brick. This is done in order to avoid placing other bricks at that location. The process then adds the evolved. brick to a brick list.

The list of bricks thus obtained. contains information about how to represent the bricks in a digital world with digital colors.

Optionally, in subsequent step S6, the process modifies the created toy construction model, e.g. by changing attributes, adding game-controlling elements and/or the like as described herein. This conversion may be at least in part be performed based on detected physical properties of the real world scene, e.g. as described above.

In subsequent step S7, the process creates a suitable output data structure representing the toy construction model. For example, in one embodiment, the bricks may be converted into bricks that are suitable to he expressed as an LXFML file.

This means that a transformation matrix may need to be calculated and, optionally, the colors may need to be converted to a valid color selected from a predetermined color palette (if not already done in the previous steps).

The transform matrix may be built to contain the rotation as a quaternion, the position and the scale (see e.g.

http://www.euclideanspace.com/maths/geometry/affine/matrix4×4/ for more detailed information on matrices and

http://www.euclideanspace.com/maths/geometry/rotations/conversions/quaternionTo Matrix/ more info on quaternion transformation). All the bricks may finally be written in a suitable data format, e.g. in the way described above for the case of an LXMF format.

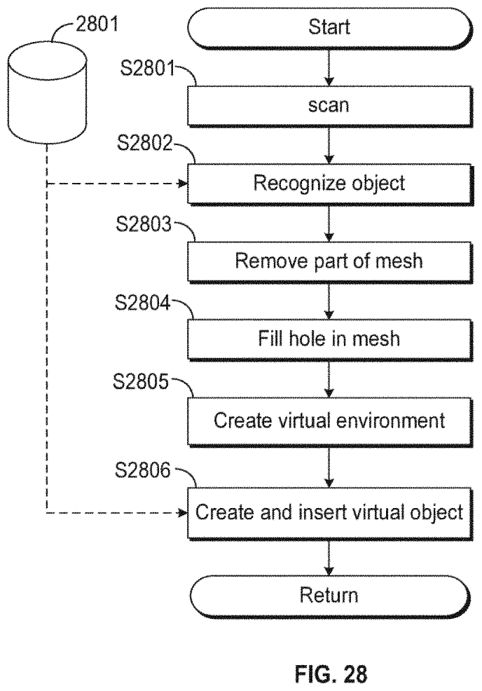

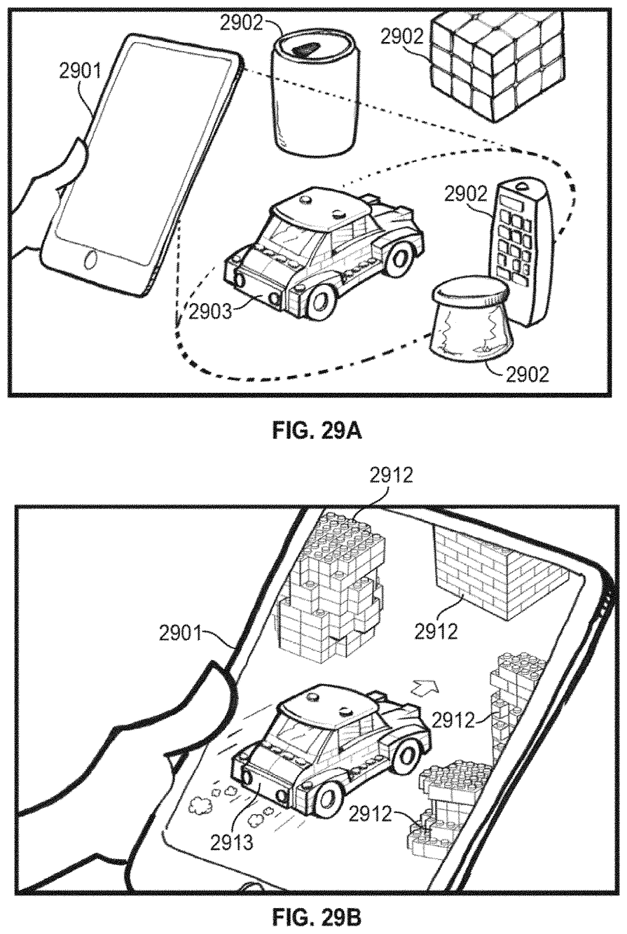

With reference to FIGS. 28. 29A-13 and 30, another embodiment of a process for creating a virtual game environment from a physical model will now be described. In particular, FIG. 28 shows a flow diagram of another embodiment of a process for creating a virtual game environment from a physical model and FIGS. 29A-B and 30 illustrate examples of steps of creating a virtual game environment from a physical model according to a further embodiment.

In initial step S2801, the process obtains scan data, i.e. a digital three-dimensional representation of the physical model, e.g. as obtained by scanning the physical model by means of a camera or other capturing device as described herein. The digital three-dimensional representation may be in the form of a surface mesh as described. herein. FIG. 29A illustrates an example of a scanning step for creating a virtual model from a physical model of a scene. The physical model of the scene comprises physical objects 2902 and 2903 arranged on a table or similar play zone. A mobile device 2901 is moved along a scanning trajectory while capturing image/scan data of the physical model. In this example, the physical objects include a number of everyday objects 2902 and a physical toy construction. model 2903 of a car.

In step S2802, the process recognizes one or more physical objects as known physical objects. To this end, the process has access to a library 2801 of known physical objects, e.g. a database including digital three-dimensional representations of each known object and, optionally, additional information such as attributes to be assigned to the virtual versions of these objects, such as functional attributes, behavioral attributes, capabilities, etc. In the example of FIGS. 29A-B, the process recognizes the physical toy construction model 2903 as a known toy construction model.

In step S2803, the process removes the triangles (or other geometry elements) from the mesh that correspond to the recognized object, thus creating a hole in the surface mesh.

In step S2804, the process fills the created hole by creating triangles filling the hole. The shape and colors represented by the created triangles may be determined by interpolating the surface surrounding the hole. Alternatively, the created surface may represent colors simulating a shadow or after-glow of the removed object.

In subsequent step S2805. the process creates a virtual environment based on the thus modified mesh, e.g. by performing the process of FIG. 21.

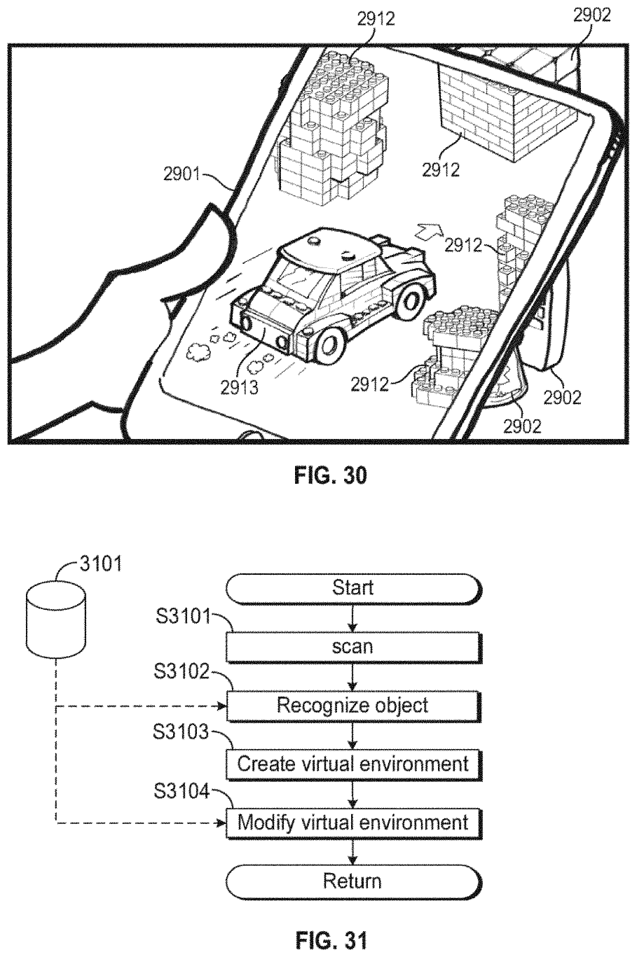

In subsequent step S2806, the process creates a virtual object based on the information retrieved from the library of know objects. For example, the virtual object may be created as a digital three-dimensional representation of a toy construction model. The virtual object may then be inserted into the created virtual environment at the location where the mesh has been modified, i.e. at the location where the object had been recognized. The virtual object is thus not merely a part of the created landscape or environment but a virtual object (e.g, a virtual item or character) that may move about the virtual environment and/or otherwise interact with the created environment. FIG. 29B illustrates an example of the created virtual environment where the physical objects 2902 of the real-world scene are represented by a virtual toy construction model 2912 as described herein. Additionally, a virtual Object 2913 representing the recognized car is placed in the virtual environment as a user-controllable virtual object that may move about the virtual environment in response to user inputs. The virtual environment of FIG. 29 is stored on the mobile device or on a remote system, e.g. in the cloud so as to allow the user to engage in digital game play using the virtual environment even when the user is no longer in the vicinity of the physical model or when the physical model no longer exists. It will be appreciated that the process may also be performed in an augmented reality context, where the virtual environment is displayed in real time while the user captures images of the physical model, e.g. as illustrated in FIG. 30.

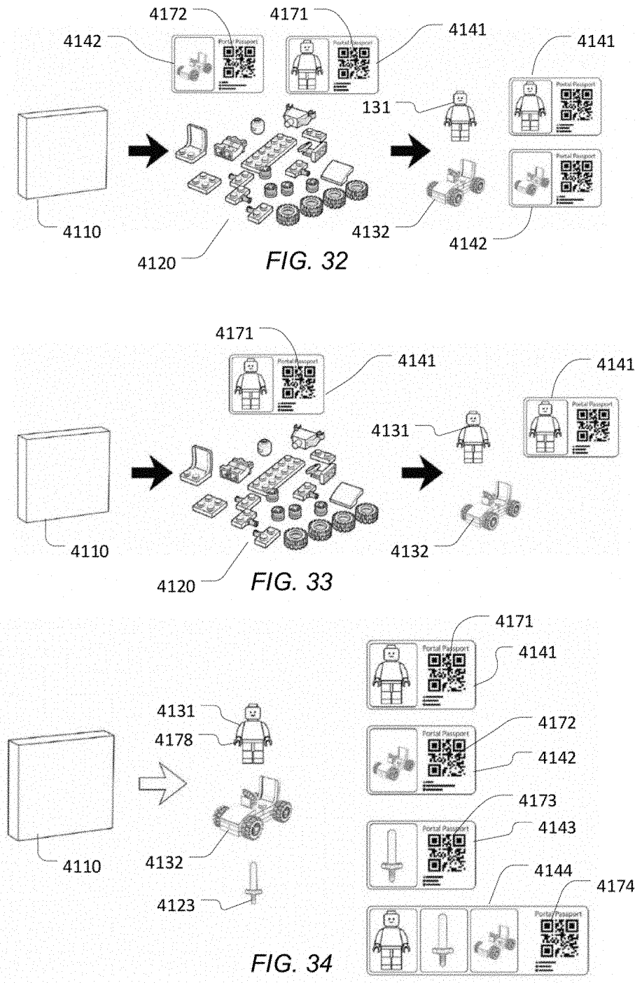

FIG. 31 shows a flow diagram of another embodiment of a process for creating a virtual game environment from a physical model.

In initial step S3101, the process obtains scan data, i.e. a digital three-dimensional representation of the physical model, e.g. as obtained by scanning the physical model by means of a camera or other capturing device as described herein. The digital three-dimensional representation may be in the form of a surface mesh as described herein.

In step S3102, the process recognizes one or more physical objects as known physical objects. To this end, the process has access to a library 3101 of known physical objects, e.g. a database including information such as information about a predetermined theme or conversion rules that are associated with and should be triggered by the recognized object.

In subsequent step S3103 the process creates a virtual environment based on the thus modified mesh, e.g. by performing the process of FIG. 21.

In subsequent step S3104, the process modifies the created virtual environment by applying one or more conversion rules determined from the library and associated with the recognized object.

It will be appreciated that, in some embodiments, the process may, responsive to recognizing a physical object, both modify the virtual environment as described in connection with FIG. 31 and replace the recognized object by a corresponding virtual object as described m connection with FIG. 28.

Embodiments of the method described herein can be implemented by means of hardware comprising several distinct elements, and/or at least in part by means of a suitably programmed microprocessor.

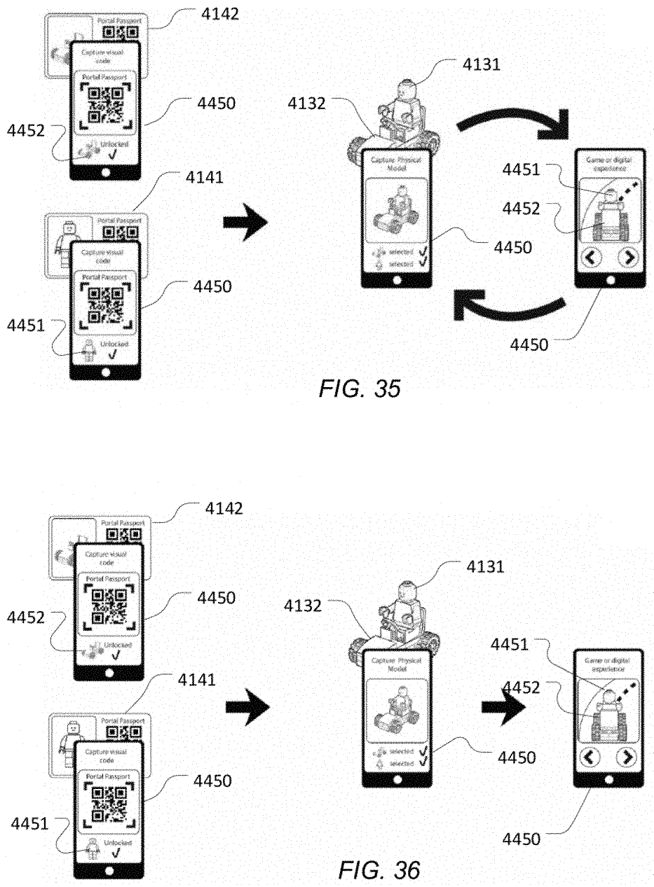

Turning now to FIG. 32, an example of a toy construction set of a toy system described herein is schematically illustrated. The toy construction set is obtained in a box 4110 or other form of packaging,. The box includes a plurality of conventional toy construction elements 4120 from which one or more (two in the example of FIG. 32) toy construction models 4131, 4132 can be constructed. In the example of FIG. 32, a toy figurine 4131 and a toy car 4132 can be constructed from the toy construction elements of the set. The toy construction set further comprises two cards 4141, 4142, e.g, made from plastic or cardboard. Each card shows an image or other representation of one of the toy construction models and a machine readable code 4171, 4172, in this example a QR code, which represents an unlock code for a virtual object associated with the respective toy construction model, e.g. a virtual character and a virtual car, respectively. Alternatively, the unlock code(s) may be provided to the user in a different manner, e.g. by mail or sold separately. Hence, each unlock code is a unique code that comes with the product or is given to the user, in the form of a physical printed code or a digital code. The unlock code(s) when used (e.g. scanned or typed in) then unlocks the possibility of using, computer vision to select the unlocked virtual object in/for a digital experience.

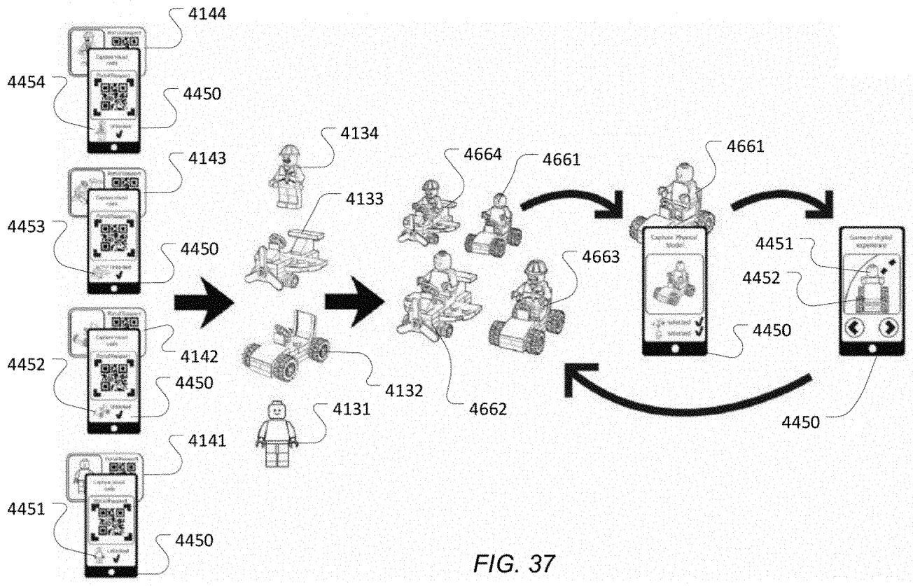

FIG. 33 schematically illustrates another example of a toy construction set, similar to the set of FIG. 1 in that the toy construction set is obtained in a box 4110 and that the box includes a plurality of conventional toy construction elements 4120 from which one or more (two in the example of FIG. 33) toy construction models 4131, 4132 can be constructed. However, in this example, the toy construction set only includes a single card 4141 with an unlock code 4171 associated with one of the toy construction models (in this example figurine 4131) that can be constructed front the toy construction elements of the set. It will be appreciated that, in other embodiments, the set may include one or more unlock codes for unlocking one or more virtual objects associated with any subset of toy construction models constructible from the toy construction elements of the set.

FIG. 34 schematically illustrates another example of a toy construction set, similar to the set of FIG. 32. However, in this example, the toy construction set includes toy construction elements (not explicitly shown) for constructing the figurine 4131 and the car 4132 and an additional toy construction element 4123, in this example a sword 4123 that can be carried by the figurine 4131, i.e. that can be attached to a hand 4178 of the figurine 4131.

The set may include three cards 4141-4143 with respective unlock codes 4171-4173, one code 4171 associated with the figurine 4131, another code 4172 associated with the car 4132 and yet another code 4173 associated with the sword 4123, ln an alternative embodiment, the set may include a card 4144 with a single unlock 4174 code for unlocking multiple virtual objects associated with the figurine, the car and the sword, respectively. Again, it will be appreciated that, instead of providing a card 4144, the single unlock code may be provided in a different manner.

FIG. 35 illustrates an example of a use of the toy system described herein, using the toy construction set of any of FIGS. 32-34 and a suitably programmed portable device 4450, e.g. a tablet or smartphone executing an app that implements a digital game of the toy system. As in the previous examples, the toy construction set includes toy construction elements (not explicitly shown for constructing a figurine 4131 and a car 4132.

Initially, the processing device reads the one or more unlock codes included in the toy construction set, e.g. from respective cards 4141 and 4142 as described above. This causes the corresponding virtual objects 4451, 4452 (in this example a virtual car 4452 and a virtual character 4451) to be unlocked. The user may then capture an image of the toy figurine 4131 positioned in the driver's seat of the toy car 41.32. The processing device 4450 recognises the figurine and the car making up the thus constructed composite model causing the digital game to provide a play experience involving a virtual car 4452 driven by a corresponding virtual character 4451. After completion of the play experience, the user may capture another image of the same or of a different toy construction model and engage in the same or a different play experience involving the corresponding unlocked virtual objects.

Hence, while a virtual object may only need to be unlocked once it may, once unlocked, be available multiple times (e.g. a limited number or an unlimited number of times) for selection as a part of a play experience. The selection is performed by capturing an image of the corresponding physical toy construction element or model.

FIG. 36 illustrates an example of another use of the toy system described herein, e.g. using the toy construction set of any of FIGS. 32-34 and a suitably programmed portable device 4450, e.g, a tablet or smartphone executing an app that implements a digital game of the toy system. The example of FIG. 36 is similar to the example of FIG. 35. However, while the use of FIG. 35 allows the virtual objects 4451, 4452 to repeatedly be selected, optionally in different combinations with other objects, the use of FIG. 36 only allows a single selection of an unlocked virtual object. Once a combination is selected, it is the thus selected combination that is used in the play experience.

FIG. 37 illustrates an example of another use of the toy system described herein, e.g. using the toy construction set of any of FIGS. 32-34 and a suitably programmed portable device 4450, e.g. a tablet or smartphone executing an app that implements a digital game of the toy system. The example of FIG. 37 is similar to the example of FIG. 35. In particular, the toy system of FIG. 37 comprises toy construction elements from which a number of toy construction models 4131-4134 can be constructed. The toy system further comprises four cards 4141-4144 with unlock codes for unlocking four virtual objects 4451-4454, each corresponding to one of the toy construction models 4131-4134.

In the example of FIG. 37 the user has unlocked four virtual objects 4451-4454 that can be combined in different ways in the digital game by capturing images of corresponding composite toy construction models 4661-4664 constructed from respective combinations of the individually recognizable toy construction models. In particular, composite toy construction model 4661 is constructed from figurine 4131 and car 4132, composite toy construction model 4662 is constructed from figurine 4131 and car 4133, composite toy construction model 4663 is constructed from figurine 4134 and car 4132, and composite toy construction model 4664 is constructed from figurine 4134 and car 4133.

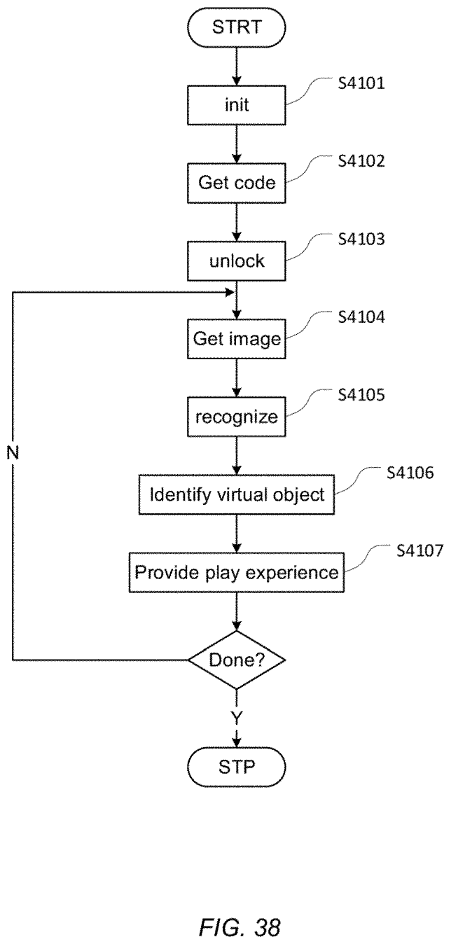

FIG. 38 shows a flow diagram of an example of a computer implemented process for controlling a digital game of a toy system, e.g, of any of the toy systems described in connection with FIGS. 32-37. In particular, the process may be executed by a processing device including a digital camera and a display, such as a mobile phone, a tablet computer or another personal computing device.

In initial step S4101, the process initiates execution of a digital game, e.g. by executing a computer program stored on a processing device. The digital game provides functionality for acquiring unlock codes, capturing images of toy construction models, recognizing toy construction models in the captured images, and for providing a digital play experience involving one or more virtual objects.

In step S4102. the process acquires an unlock code, e.g. by reading a QR code, reading an RFID tag, receiving a code manually entered by a user input, or in another suitable way.

In subsequent step S4103, the process unlocks a virtual object associated with the received unlock code. For example, the digital game may have stored information about a plurality of virtual objects, each virtual object having associated with it a stored unlock code or a set of unlock codes. The process may thus compared the acquired unlock code with the stored. unlock codes or codes so as to identify which virtual object to unlock. The process may then flag the virtual object as unlocked. In some embodiments, the process may be implemented by a distributed system, e.g. including a client device and a remote host system, e.g. as described in connection with FIG. 42. In such a system, the processing device may forward the acquired unlock code to the host system and the host system may respond with information about a virtual object to be unlocked.

In step S4104, the process receives an image of a toy construction model. For example, the image may be an image captured by a digital camera of the device executing the process. The image may directly be forwarded from the camera to the recognition process. To this end, the process may instruct the user to capture an image of a toy construction model constructed by the user, where the toy construction model represents the unlocked virtual object. In some embodiments, the process may initially display or otherwise present building instructions instructing the user to construct a predetermined toy construction model. The process may receive a single captured image or a plurality of images, such as a video stream, e.g. a live video stream currently being captured by the camera.

In step S4105, the process processes the received image in an attempt to recognize a known toy construction model in the received image. For example, the process may feed the captured image into a trained machine learning algorithm, e.g. a trained neural network, trained to recognize each of a plurality of target toy construction models. An example of a process for recognizing toy construction models is described in WO 2016/075081. However, it will be appreciated that other image processing and vision technology techniques may be used for recognizing toy construction models in the received image. It will further be appreciated that the recognition process may recognize the toy construction model as a whole or the process may recognize individual toy construction elements of the model, e.g. one or more marker toy construction elements comprising a visual marker indicative of the toy construction model.

If the process fails to recognize a known toy construction model, the process may repeat step S4105 to receive a new image. Repeated failure to recognize a known toy construction model may cause the process to terminate or to proceed in another suitable manner, e.g. requesting the user to capture another image of another toy construction model.

When the process has recognized a known toy construction model in the received image, the process proceeds at step S4106 where the process determines whether an unlocked virtual object is associated with the recognized toy construction model. To this end, the process may compare the recognized toy construction model with a list of known toy construction models, each known toy construction model having a respective virtual object associated with it. Moreover, each virtual object may have a locked/unlocked flag associated with it. Hence, only when the recognized toy construction model has a virtual model associated with it where the unlock flag is set, the process determines that an unlocked virtual object is associated with the recognized toy construction model.

When the process determines that an unlocked virtual object is associated with the recognized toy construction model, the process proceeds at step S4107. Otherwise, the process may terminate, inform the user that the corresponding virtual object needs to be unlocked, or proceed in another suitable manner.

At step S4107, the process provides a digital play experience involving the virtual object that is associated with the recognized to construction model. For example, the process may start a play experience with the identified virtual object, or the process may add the virtual object to an ongoing play experience.

After completion of the play experience, or responsive to a game event or a user input, the process may return to step S4104 allowing the user to acquire an image of another toy construction model. Alternatively, the process may terminate.

It will be appreciated that various modifications to the above process may be implemented. For example, the process may recognize parts of a toy construction model and determine whether unlocked virtual objects are associated with one or each of the recognized parts and provide a play experience involving a combination of these unlocked virtual objects, e.g. only if all recognized parts have an unlocked virtual object associated with it. Examples of such a process are described in connection with FIGS. 35-37. The recognized parts may be individual toy construction elements or toy construction models that are interconnected to form a combined model. Alternatively or additionally, the process may restrict use of the unlocked virtual objects, e.g. to a single use or a predetermined number of uses, to certain combinations with other objects, and/or the like.

Alternatively or additionally, steps S4105 and S4106 may be combined into a single operation. For example, the process may only recognize toy construction models as known toy construction models if they have an unlocked virtual object associated with it.

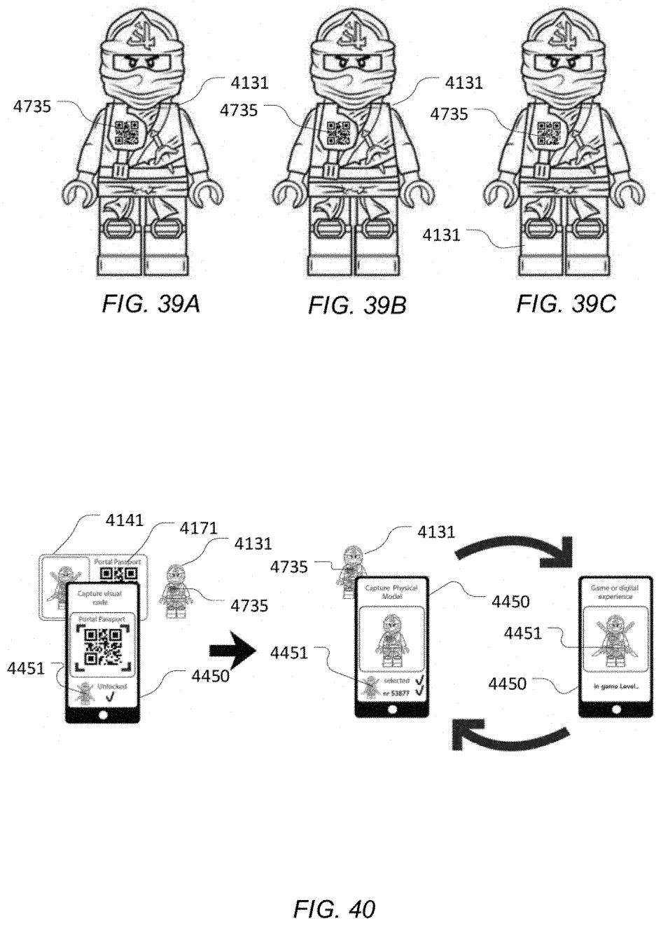

Yet alternatively or additionally, in step S4105, the process may further detect an object code applied to a recognized toy construction model, e.g. by reading a QR code or another type of visually recognizable code from the captured image. For example, during manufacturing of a toy construction element, a data processing system executing an encoder may convert a bit string or other object code into a visually recognizable code, such as a QR code, a graphic decoration, and/or the like. The encoded visually recognizable code may then be printed on the toy construction element, e.g. on a torso of a figurine as illustrated in FIGS. 39A-C.

During step S4105, a decoding function may analyse an image of a toy construction model and extract the object code that was embedded by the encoder. The decoding function may be based on a QR code reading function, a neural network trained to convert encoded images into their object code counterparts, or the like. Error correction codes can be added to the object code so that a number of erroneous output bits can he corrected. In one embodiment, the process may initially recognize the toy construction model, identify a portion of the recognized toy construction model where an object code is expected, and feed a part image depicting the identified portion, e.g. the torso of a recognized figurine to the decoding function.

In step S4106, in addition to determining the unlocked virtual object corresponding to the recognized toy construction model, the process may further identify a particular instance of the unlocked virtual object based on the detected object code. To this end, the process may maintain records associated with multiple instances of a particular virtual object, each instance being associated with a respective object code and, optionally with respective attributes, such as health, capabilities, etc.

FIGS. 39A-C illustrate examples of toy construction models 4131. The toy construction models of FIGS. 39A-C are figurines, each constructed from multiple toy construction elements, in particular toy construction elements forming the head, the torso, the legs, respectively, of the figurine. It will be appreciated that, alternatively, each figurine may be formed as a single toy construction element. It will also be appreciated that other toy construction models may represent other items, e.g. a vehicle, a building, an animal, etc. Each figurine has applied to it a computer readable visual code 4735 encoding a serial number or another form of identifier which may uniquely or non-uniquely identify a particular figurine. In the example of FIGS. 39A-C the visual code is printed on the torso of the figurine. However, in other examples the code may be applied to other parts of the model or even be encoded by visual markers applied to respective parts of the model. Hence, even though the figurines 4131 of FIGS. 39A-C have identical shape, size and decoration apart from the code 4735, a computing device having a code reader may distinguish them from each other. Accordingly, as the figurines of FIGS. 39A -C are perceptually very similar to the human observer (in some embodiments they may even be substantially indistinguishable), the end user will not easily notice the difference between two figurines. Moreover, embodiments of the process described herein may recognize the figurines as representing the same virtual object, in particular the same virtual character. However, a single unlock code may unlock all instances of the virtual object.

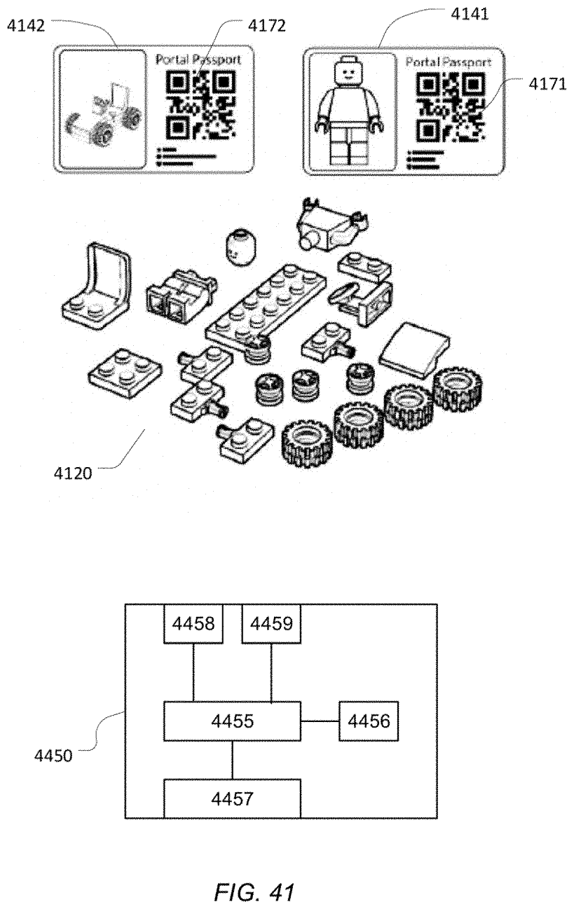

FIG. 40 illustrates an example of a use of the toy system described herein, e.g. including figurines as described in connection with FIGS. 39A-C and a suitably programmed portable device 4450, e.g. a tablet or smartphone executing an app that implements a digital game of the toy system. As in the previous examples, the toy construction system includes toy construction elements (not explicitly shown) for constructing a figurine 4131. The toy construction system further comprises a card 4141 including an unlock code 4171.

Initially, the processing device 4450 reads the unlock code 4171 included, in the toy construction set, e.g. from card 4141. This causes the corresponding virtual object 4451 (in this example a virtual character) to be unlocked. The user may then capture an image of the figurine 4131 carrying one of a set of object codes 4735. The processing device recognises the figurine including the particular code 4735 applied to the figurine. This causes the digital game executed by the processing device 4450 to provide a play experience involving an instance of the virtual character 4451. After completion of the play experience, the user may capture another image of the same or of a different figurine, in particular a figurine resembling figurine 4131 but having a different object code 4735 applied to it. This allows the user to engage in the same or a different play experience involving a different instance of the virtual character. Accordingly, the digital game may store or otherwise maintain game progress (such as health levels, capability levels, or other progress) for respective instances of a virtual character. For example, if two users each have their own figurine with respective object codes, they may both use the processing device 4450 to engage in the digital game using respective instances of the same virtual character, in particular where the virtual character has respective in-game progress.

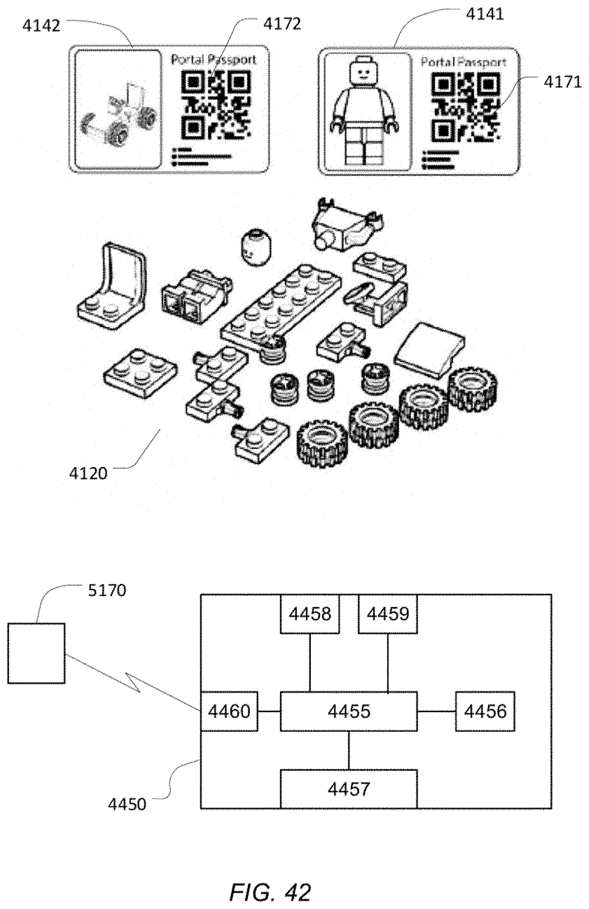

FIG. 41 schematically illustrates an example of a toy system described herein. The toy system includes a plurality of toy construction elements 4120 from which one or more toy construction models can be constructed, e.g. as described in connection with FIG. 32. The toy system further comprises two cards 4141, 4142, e.g. made from plastic or cardboard. Each card shows an image or other representation of one of the toy construction models and a machine readable code 4171, 4172, in this example a QR code, which represents an unlock code for a virtual object associated with the respective toy construction model, e.g. a virtual character and a virtual car, respectively. Alternatively, the unlock code(s) may be provided to the user in a different manner, e.g. by mail or sold separately. Hence, each unlock code is a unique code that comes with the product or is given to the user through a physical printed code or a digital code. The unlock code(s) when used (scanned or typed in) then unlocks the possibility of using computer vision to select the object in/for a digital experience.

The toy system further comprises a suitably programmed processing device 4450, e.g. a tablet or smartphone or other portable computing device executing an app that implements a digital game of the toy system. The processing device 4450 comprises a central processing unit 4455, a memory 4456, a user interface 4457, a code reader 4458 and an image capture device 4459.

The user interface 4457 may e.g. include a display, such as a touch screen, and, optionally input devices such as buttons, a touch pad, a pointing device, etc.

The image capture device 4459, may include a digital camera, a depth camera, a stereo camera, and/or the like.

The code reader 4458 may be a barcode reader, and RFID reader or the like, M some embodiments, the code reader may include a digital camera. In some embodiments, the code reader and the image capture device may be a single device. For example, the same digital camera may be used to read the unlock codes and capture images of the toy construction models.

FIG. 42 schematically illustrates another example of a toy system described. The toy system of FIG. 42 is similar to the toy system of FIG. 41, the only difference being that the processing device 4450 further comprises a communications interface 4460, such as a wireless or wired communications interface allowing the processing device 4450 to communicate with a remote system 5170. The communication may be wired or wireless. The communication may be via a communication network. The remote system may be a server computer or other suitable data processing system which may be configured to implement one or more of the processing steps described herein. For example, the remote system may maintain a database of unlock codes in order to determine whether a given unlock code has previously been used to unlock a virtual object. Alternatively or additionally, the remote system may maintain a database of object codes. Yet alternatively or additionally, the remote system may implement an object recognition process or parts thereof for recognizing toy construction models in captured images. Yet alternatively or additionally, the remote system may implement at least a part of the digital game, e.g. in embodiments where the digital game includes a multiplayer play experience or a networked play experience.

Hence, generally, a virtual object needs to be unlocked only once by the unique unlock code. The selection of the virtual object (or of multiple/composite virtual objects at one time) can be done every time the virtual object is to be used in the digital experience or for a one-dine use.

In the claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

What is claimed is:

1. A toy system, comprising: a plurality of toy construction elements, an image capturing device and a processor, wherein the image capturing device is operable to capture one or more images of a toy construction model constructed from the toy construction elements: wherein the processor is configured to:
execute a digital game, the digital game comprising computer executable code configured to cause the processor to provide a digital play experience;
receive an unlock code indicative of one or more virtual objects;
responsive to receiving the unlock code, unlock the one or more virtual objects associated with said received unlock code for use in the digital play experience, each virtual object being associated with a respective one of said toy construction elements or with a respective toy construction model constructed from the toy construction elements;
receive one or more images captured by said image capturing device;
recognize one or more toy construction elements or toy construction models with the one or more images;
responsive to recognizing a first toy construction element or a first toy construction model associated with a first one of the unlocked virtual objects, provide a digital play experience involving said first unlocked virtual object.

2. A toy system according to claim 1, wherein the unlock code is provided as a physical item carrying a machine readable or human readable code.

3. A toy system according to claim 1, wherein the unlock code is of limited-use and wherein the processor is configured to determine whether the received unlock code has previously been used beyond the limited use, and to unlock the virtual object only, if the code has not previously been used beyond the limited use.

4. A toy system according to claim 1, wherein the digital game comprises computer executable code configured to cause the processor to control at least one virtual game item.

5. A toy system according to claim 1, wherein the unlocked first virtual object has a visual appearance that resembles the first toy construction element or model with which the first virtual object is associated.

6. A toy system according to claim 1, wherein the processor is configured, responsive to receiving the unlock code, to associate a visual appearance to the unlocked virtual object, in particular by receiving one or more captured images of a toy construction model whose visual appearance is to be associated with the unlocked virtual object; and to associate the visual appearance of said toy construction model with the unlocked virtual object.

7. A toy system according to claim 1, wherein the received one or more images, within which the processor recognizes one or more toy construction elements or toy construction models, depicts a composite toy construction model constructed from at least a first toy construction model and a second toy construction model; wherein recognizing one or more toy construction elements or toy construction models within the one or more images comprises recognizing each of the first and second toy construction models included in the composite toy construction model; and wherein the processor is configured, responsive to recognizing the first and second toy construction models, to provide a digital play experience involving said first and second unlocked virtual objects, wherein the first toy construction model is associated with a first unlocked virtual object and the second toy construction model is associated with a second unlocked virtual object

8. A toy system according to claim 7, wherein the processor is configured to further recognize a spatial configuration of the first and second toy construction models relative to each other, and to modify the provided play experience responsive to the recognized spatial configuration.

9. A toy system according to claim 1, wherein one or more of the plurality of toy construction elements may include a visually recognizable code identifying a toy construction element or a toy construction model.

10. A toy system according to claim 9, wherein the plurality of toy construction elements includes one or more marker toy construction elements each having a visual appearance representative of an object code or a part thereof.

11. A toy system according to claim 10, wherein the processor is configured to detect the object code within the one or more images and to adapt the digital play experience responsive to the detected object code.

12. A toy system according to claim 1, wherein recognizing the first toy construction element or the first toy construction model associated with the first unlocked virtual object comprises:
recognizing the first toy construction element as a toy construction element of a first type of toy construction elements or recognizing the first toy construction model as a toy construction model of a first type of toy construction models; and
detecting a first object code associated with the recognized first toy construction element or the recognized first toy construction model.

13. A toy system according to claim 12, wherein the processor is configured, responsive to recognizing the first toy construction element or the first toy construction model, to provide a digital play experience involving a first instance of a plurality of instances of said first unlocked virtual object, the first virtual object being associated with the first type of toy construction element or the first type of toy construction model, and each of the plurality of instances of said virtual object being further associated with a respective object code.

14. A toy system according to claim 13, wherein the processor is configured, responsive to recognizing the first toy construction element or the first toy construction model associated with a first one of the unlocked virtual objects, to store the detected first object code associated with the first unlocked virtual object.

15. A toy system according to claim 14, wherein the processor is configured to determine whether an object code has previously been stored associated with the first unlocked virtual object and to associate the detected first object code with the first unlocked virtual object only if no object code has previously been associated with the first unlocked virtual object.

16. A toy system according to claim 15, wherein the processor is configured to compare the detected first object code with a previously stored object code associated with the first unlocked virtual object, and to provide the digital play experience involving said first unlocked virtual object only if the detected first object code corresponds to the previously stored object code associated with the first unlocked virtual object.

17. A method, implemented by a processor, of operating a toy system, the toy system comprising a plurality of toy construction. elements, an image capturing device, and the processor, the image capturing device being operable to capture one or more images of one or more toy construction models constructed from the toy construction elements and placed within a field of view of the image capturing device, wherein the method comprising:
executing a digital game, the digital game comprising computer executable code configured to cause the processor to provide a digital play experience;
receiving an unlock code indicative of one or more virtual objects;
responsive to receiving the unlock code, unlocking the one or more virtual objects associated with said received unlock code for use in the digital play experience, each virtual object being associated with a respective one of said toy construction elements or with a respective toy construction model constructed from the toy construction elements;
receiving one or more images captured by said image capturing device;
recognizing one or more toy construction elements or toy construction models within the one or more images; and
responsive to recognizing a first toy construction element or a first toy construction model associated with a first one of the unlocked virtual objects, providing a digital play experience involving said first unlocked virtual object
